(19) United States
(12) Patent Application Publication
(10) Pub. No.: US 2004/0158475 A1
(43) Pub. Date: Aug. 12, 2004

(54) System and method for data handling in pharmaceutical manufacture

(76) Inventors: Harry Juzeszyn, Beecher, IL (US); J. Andy Newsom, Manteno, IL (US); Teresa Warman, Clifton, IL (US); Jennifer Berg, Bourbonnais, IL (US)

Correspondence Address: MORGAN & FINNEGAN, L.L.P., 345 Park Avenue, New York, NY, 10154-0053, US

(21) Appl. No.: 10/360,153

(22) Filed: Feb. 6, 2003

(51) Int. Cl. G06F 17/60

(52) U.S. Cl. 705/1

(57) ABSTRACT

This invention relates to systems and methods applicable to handling, for example, pharmaceutical batch record review, events occurring during pharmaceutical batch product manufacture, and/or pharmaceutical batch product disposition determination.

Certain of these systems and methods may be implemented in a manner compliant with 21 CFR Code of Federal Regulations, Part 11 (21 CFR Part 11).

This application claims the benefit of U.S. Provisional Application No. 60/355,360, filed Feb. 6, 2002, which is incorporated herein by reference.

### FIELD OF INVENTION

This invention relates to systems and methods for pharmaceutical manufacture.

### BACKGROUND INFORMATION

In recent years, there has been an increase in the use of computers in various industries. Such use can yield benefits such as increased speed and accuracy.

Perhaps even more so than other industries, the pharmaceutical industry is one in which increased speed and accuracy are important. One reason for this is the desire not only to provide quality products and services, but also to do so without needless expenditure of capital. Thus, there is an interest in technologies that facilitate the use of computers in various aspects of the pharmaceutical industry.

Furthermore, on Aug. 20, 1997, 21 Code of Federal Regulations Part 11 (“21 CFR Part 11”) went into effect. 21 CFR Part 11 sets forth how electronic records, electronic signatures, and the like are to be handled in the pharmaceutical industry. Accordingly, it may be desirable to provide a solution for employing computers in various aspects of the pharmaceutical industry to facilitate compliance with 21 CFR Part 11.

### SUMMARY OF THE INVENTION

According to embodiments of the present invention, there are provided systems and methods applicable to handling, for example, pharmaceutical batch record review, events occurring during pharmaceutical batch product manufacture, and/or pharmaceutical batch product disposition determination.

Certain of these systems and methods may be implemented in a manner compliant with 21 CFR Part 11.

### BRIEF DESCRIPTION OF THE DRAWINGS

FIG. 1 is a flowchart showing exemplary steps performed in batch record and product disposition handler module operation in accordance with various embodiments of the present invention.

FIG. 2 is a flowchart showing exemplary steps performed in excursion handler module operation in accordance with various embodiments of the present invention.

FIG. 3 is a flowchart showing exemplary steps performed in environmental monitoring and corrective action report handler module operation in accordance with various embodiments of the present invention.

FIG. 4 is a flowchart showing exemplary steps performed in deviation handler module operation in accordance with various embodiments of the present invention.

FIG. 5 is a flowchart showing exemplary steps performed in planned process modification handler module operation in accordance with various embodiments of the present invention.

FIG. 6 is a flowchart showing exemplary steps performed in comment handler module operation in accordance with various embodiments of the present invention.

FIG. 7 is a flowchart showing exemplary steps performed in supplement handler module operation in accordance with various embodiments of the present invention.

FIG. 8 shows an exemplary general purpose computer employable in various embodiments of the present invention.

FIG. 9 shows a conceptual overview relating to an example corresponding to various embodiments of the present invention.

FIG. 10 illustrates a high-level process flow of an excursion relating to an example corresponding to various embodiments of the present invention.

FIG. 11 illustrates a high-level process flow of an environmental monitoring and corrective action report relating to an example corresponding to various embodiments of the present invention.

FIG. 12 illustrates a high-level process flow of a comment relating to an example corresponding to various embodiments of the present invention.

FIG. 13 illustrates a high-level process flow of a deviation relating to an example corresponding to various embodiments of the present invention.

FIGS. 14a and 14b illustrate high-level process flows of a planned process modification relating to an example corresponding to various embodiments of the present invention.

FIGS. 15a and 15b illustrate high-level process flows of supplements relating to an example corresponding to various embodiments of the present invention.

FIG. 16 illustrates a high-level process flow of a batch record relating to an example corresponding to various embodiments of the present invention.

### DETAILED DESCRIPTION OF THE INVENTION

General Operation

Embodiments of the present invention provide systems and methods employable, for instance, in handling pharmaceutical batch record review, events occurring during pharmaceutical batch product manufacture, and/or pharmaceutical batch product disposition determination.

Batch record review handling might include, for instance, the creation of a batch record corresponding to a pharmaceutical batch, the addition of certain data to the batch record, and/or the procurement of approval for the batch record. Data added to the batch record might include for instance, event data and production information data. Procurement of approval might include, for example, the collection of electronic signatures from one or more individuals.

Handling of an event might include, for instance, the creation of an event record corresponding to the event, the notification of various entities to perform various actions regarding the event, the addition to the event record of information regarding those actions, and/or the collection of electronic signatures corresponding to those actions. Events may include, for instance, excursion events, Environmental Monitoring and Correction Action Report (EMCAR) events, deviation events, planned process modification (PPM) events, and/or supplement events. Actions performed regarding events may include, for instance, investigations, regulatory compliance actions, and/or approval actions.

For various embodiments of the present invention, pharmaceutical batch disposition determination might include, for instance, the resolution of holds on the release of a pharmaceutical batch. Such a hold may, for instance, relate to stability sampling, a regulatory compliance check, a manufacturing work-in-progress (WIP) component association issue, a change control request, or a validation study. For various embodiments of the present invention, an override approval, perhaps in the form of a digital signature, might be employed in the resolution of a hold.

Various aspects of the present invention will now be discussed in greater detail.

Batch Record and Product Disposition Handler Module

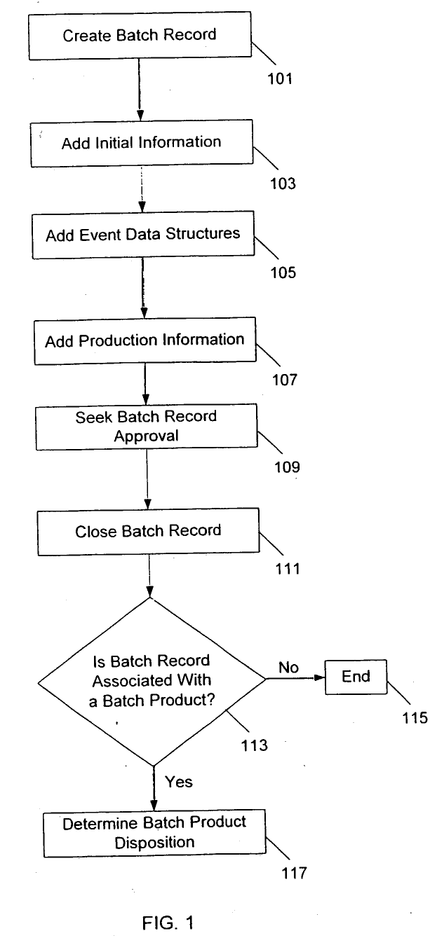

Various embodiments of the present invention may employ a batch record and product disposition (BRPD) handler software module for dealing with batch records and the disposition of batch products corresponding to batch records. With reference to FIG. 1, BRPD handler module functionally will now be discussed.

As a first step, a batch record corresponding to a pharmaceutical batch may be created by a BRPD module (step 101). The BRPD module might perform such an action, for instance, upon receipt of a request to do so dispatched by one or more authorized individuals. Included with the request could be one or more electronic signatures. The BRPD handler module could, perhaps by consulting an accessible store in light of received electronic signatures, determine if the one or more individuals submitting such a request were authorized to do so.

After batch record creation, certain initial information components corresponding to the batch could be added to the batch record by the BRPD handler module (step 103). The initial information components could include for instance, one or more controlled documents such as manufacturing procedures (MPRs), standard operating procedures (SOPs), specifications, computer program information, and/or equipment information associated with the batch.

In certain embodiments, an MPR component could be associated with one or more other components, and work-in-progress (WIP) information could be established to describe the association. Such WIP information could, for instance, specify that certain components associated with an MPR were required to present and/or complete before the pharmaceutical batch associated with the MPR could be released. Components associated with an MPR could include, for example, components of the sort noted above such as SOPs, specifications, computer program information, equipment information, and/or other MPRs.

As a next step, the BRPD handler module could add the one or more received event data structures to the batch record (step 105). Such a received event data structure could be, for example, an EMCAR or deviation. Such data structures will be discussed in greater detail below. After this, the BRPD handler module could add to the batch record production information relating to the batch product (step 107). The production information could include, for instance, data received, collected and/or recorded before, during, and/or after batch product manufacture.

All or certain aspects of such data could, for example, be received after entry at a data terminal by an employee or the like working on the production of the batch. In certain embodiments of the present invention, such an employee might submit an electronic signature in conjunction with such data entry and/or perform an appropriate log-in. Details of such electronic signatures and log-ins will be discussed in greater detail below.

As another example, all or certain aspects of such data could be collected from equipment involved in the production of the batch. More specifically, the production information could include elements such as, for example, information regarding the starting materials for the batch product, information regarding one or more process date entries relating to the batch product, and/or information regarding materials discarded during manufacture of the batch product. It is specifically noted that, in various embodiments of the present invention, step 107 could take place before step 105. It is further noted that, in various embodiments of the present invention, steps 105 and 107 may take place simultaneously.

Next, approval of the batch record could be facilitated by the BRPD handler module. For various embodiments of the present invention, a store accessible by the BRPD handler module could include specification of the criteria that needed to be met for the record to be considered “approved”. For instance, such a specification could indicate that, for a particular batch record to be considered “approved”, each of one or more specified individuals would each need to indicate that the record, or a portion thereof, is acceptable. Accordingly, the BRPD handler module may act to seek approval for the batch record (step 109).

As a first step in seeking such approval, the BRPD handler module could act to consult the specification in order to determine the criteria that needed to be met for the record to be considered “approved”.

Next, the BRPD handler module could take steps to collect data necessary to evaluate if these criteria are met. In, for example, the case where the input of one or more individuals was specified to be required, appropriate notifications could be dispatched to the one or more individuals. Each such notification might specify that the recipient individual needed to indicate the batch record to be either acceptable or not acceptable.

Accordingly, a recipient individual logged in via a computer, terminal, or the like could be presented with a notice indicating that a specified batch record, or a portion thereof, needed to be reviewed. The notice could additionally facilitate the individual's viewing of the batch record. For instance, the notice could include a graphical user interface (GUI) button, login panel, and/or electronic signature panel that the individual could employ to view the specified batch record or batch record portion. The notice could further facilitate an entity's indication of the acceptability of a batch record or batch record portion.

Accordingly, in certain embodiments of the present invention, associated with the notice could be one or more GUI elements that allowed the recipient individual to indicate the batch record to be “approved” or “not approved”. For various embodiments of the invention, the individual could be required to submit an electronic signature along with the specification. A GUI electronic signature panel might be provided to facilitate submission of the electronic signature. Login, electronic signatures, and the like will be described in greater detail below. Upon receipt of the acceptability specification, the BRPD handler module could add it to the batch record. The BRPD handler module could also add to the batch record any received electronic signatures.

Next, the BRPD handler module could take action to determine if the criteria for approval were met. For example, the responses received from the individuals could be viewed in light of the criteria to determine if the batch record was considered to be approved. Upon determining whether the batch record was considered to be “approved” or “not approved”, the BRPD handler module could record an indication of the determination. Such an indication could be, for example, added to the batch record. Alternately or additionally, such an indication could be placed separately from the batch record, such as in a separate file or database record.

As a next step, the BRPD handler module could close the batch record. Closing could, as will be discussed below, be performed in a number of ways (step 111). In the case where the batch record is not associated with a batch product, the BRPD handler module may proceed no further in the flow depicted in FIG. 1 (steps 113, 115). Alternately, in the case where the batch record is associated with a batch product, the BRPD handler module may take action to determine the disposition of the batch product (steps 113, 117).

In determining the disposition of the batch product, the BRPD handler module might first consider if the batch record had been approved. Where the batch record was not approved, the BRPD handler module might give the batch product the disposition “rejected”, “not approved”, or the like. Where the batch record was approved, the BRPD handler might perform additional steps to determine the disposition of the batch product. For instance, the BRPD handler module might act to consider one or more holds placed on the batch product. The placement of holds on batch products will be discussed in greater detail below.

In the case where one or more holds on the batch product exist, but the BRPD handler module has determined that these holds may yet been resolved, the BRPD handler module may give the batch product the disposition “in-process”, “hold” or the like. In the case where one or more holds on the batch product still exist, but the BRPD handler module has determined that these holds will not be resolved, the BRPD handler module may give the disposition “rejected”, “not approved”, or the like. The BRPD handler module may record a chosen disposition in an accessible store and/or may add the chosen disposition to the batch record.

The distinction between a disposition of “in-process”, “hold” or the like and a disposition of “rejected”, “not approved”, or the like may, be time dependent. For instance, it may be established that a batch product's disposition be “in-process” or the like in the case where not all holds on a the product have been removed, but the time elapsed since batch record closure is less than a certain value. On the other hand, it may be established that the batch product's disposition be “rejected”, “not approved” or the like in the case where not all holds on the product have been removed, but the time elapsed since batch record closure is greater than a certain value.

As alluded to previously, a number of different types of holds may be placed on a batch product. For instance, according to various embodiments of the present invention, holds may include stability sampling holds, regulatory compliance check holds, disposition checklists holds, WIP component association issue holds, event holds, change control request holds, and/or validation study holds. Certain of these exemplary holds will now be discussed in greater detail.

A regulatory compliance check hold could be placed, for instance, by an authorized employee, supervisor, or the like involved in the production of the batch. Accordingly, such an individual might instruct the BRPD handler module to place a compliance check hold on a batch product in the case where the batch product is associated with a regulatory filing type of “CBE-30” (changes being effected within thirty days) or “Prior Approval”. Such a hold might be cleared upon the BRPD handler module receiving appropriate data and/or electronic signatures from one or more authorized individuals.

In certain embodiments of the present invention, a BRPD handler module could maintain for a batch product a checklist of tasks or the like that needed to be performed before the product could be released. Such a checklist could be populated by submissions sent to the BRPD handler module by an authorized employee, supervisor, or the like. For such embodiments, the BRPD handler module could maintain a disposition checklist hold on the batch product until all items on the checklist had been executed. The BRPD handler module could learn of execution of a checklist item, for example, via received electronic signatures from authorized individuals.

As alluded to above, WIP component association information may be associated with a batch record. Accordingly, the BRPD handler module could place a hold on a batch product in the absence of certain components specified by WIP information to be required for batch product release. The BRPD handler module could clear such a hold upon appearance of the missing components. The BRPD handler module could note the presence or absence of such components, for instance, through scanning of the batch record.

As will be described in greater detail below, various holds may be placed in conjunction with the occurrence of events. One such event hold is a stability sampling hold. A stability sampling hold could, for example, be placed with the occurrence of an environmental monitoring and corrective action report (EMCAR) event, a deviation event, or a planned process modification (PPM) event. These events will be discussed in further detail below. Such a hold might be cleared upon the BRPD handler receiving stability sampling data and/or electronic signatures from one or more authorized individuals.

In certain embodiments of the present invention, the BRPD handler module could receive validation study (VSR) and/or change control (CCR) data. Such data could be received in a number of ways. Such data could be passed to the BRPD handler module, for instance, by individuals involved in the production of the batch. Such an authorized individual might enter the data by way of a computer, terminal, or the like. Such data may include, for instance identification number, start time/date, end time/date, approval time/date, and/or impacted materials. Also provided to the BRPD handler module may be one or more electronic signatures. Having received such data, the BRPD handler module could act to place holds on one or more batch products.

For example, the BRPD handler module could place a hold on each batch product being created from materials indicated in received VSR and/or CCR impacted material data and being manufactured during a period of time falling falls within a received VSR and/or CCR start and end time. In certain embodiments of the invention, the BRPD handler module could act to clear such holds upon passing of the received VSR and/or CCR end time, perhaps after receipt of electronic signatures and/or other indications from one or more individuals.

It is noted that certain embodiments of the present invention may allow for holds on a batch product to be cleared by submission of electronic signature or the like by one or more authorized individuals. Accordingly, the BRPD handler module could have access to a specification of what was required to execute override. For instance, such a specification could state that an electronic signature of a certain individual was sufficient to execute override. As another example, such a specification could state that an electronic signature of any one of a specified group of individuals was sufficient to execute override. As yet another example such a specification could state that the electronic signatures of each one of a specified group of individuals was required to execute override. In certain embodiments, such a specification could apply to all batch products or only specified batch products.

Excursions and EMCAR Events

In various embodiments of the present invention, there may be access to an environment control (EC) software module. Such an EC program module may, perhaps via interaction with other software modules, equipment, personnel, or the like, act during the production of a batch product to monitor air, surfaces, equipment, the batch product, and/or the like in order to determine type and/or number of microorganisms present. The EC program module may maintain and/or have access to an EC behavior specification describing how it should behave. Such a specification might state, for instance, monitoring methods, monitoring schedules, alert limits, action limits, and/or actions to perform under certain conditions. For instance, such a specification might state actions to be performed upon exceeding an alert limit, actions to be performed upon exceeding an action limit, particular microorganisms and/or groups of microorganisms for which monitoring should be performed, and/or the like. Alert limits and action limits might, for instance, be listed for specific microorganisms and/or groups of microorganisms, and might be specified in parts per million (PPM).

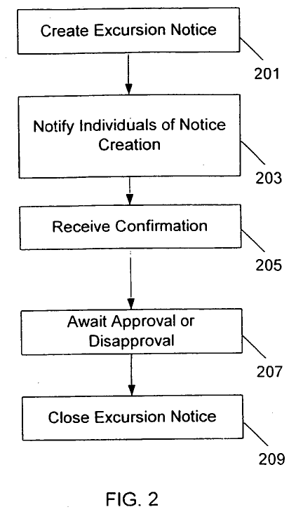

For example, an EC behavior specification might state that, upon exceeding an alert limit, the EC program module should notify an appropriate software module of a need to create an excursion notice. For various embodiments of the present invention, such an appropriate software module might be known as an excursion handler module. The functionality of an excursion handler module will be discussed below with reference to FIG. 2.

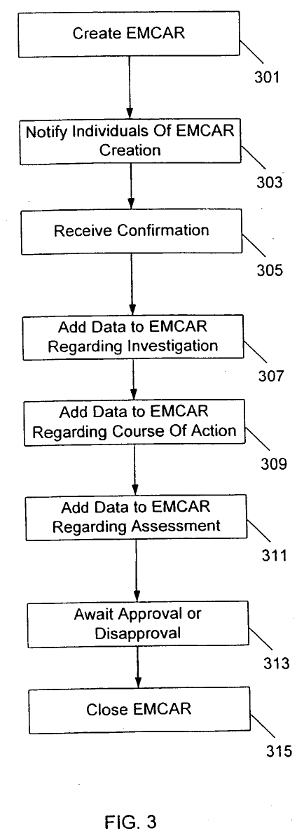

As another example, an EC behavior specification might state that, upon exceeding an action limit, the EC program module should notify an appropriate software module of a need to create an environmental monitoring and corrective action report (EMCAR). For various embodiments of the present invention, such an appropriate software module might be known as an EMCAR handler module. The functionality of an EMCAR handler module will now be discussed below with reference to FIG. 3.

With reference to FIG. 2 it is noted that, upon receiving notification from an EC program module that an excursion notice should be created with regard to the production of a particular batch product, an excursion handler module could act to create such an excursion notice (step 201), for example, by creating a record in a database or by creating a file in a filesystem. The database or filesystem could be the same one used by the BRPD handler module, or could be separate. Included in the notice could be, for example, details of the type of assessment, location where the alert limit was exceeded, and/or the date/time when the alert limit was exceeded.

In certain embodiments, the excursion handler module might not automatically create an excursion notice upon receiving notice from an EC module. Instead, the excursion handler module might advise one or more individuals that an excursion notice should be created. In response, one or more of the individuals could give the excursion handler module permission to create the excursion notice. An indication of the individuals to be notified might be found by consulting an accessible store. Alternately, the indication might be included in the above-noted specification of how the excursion handler module should behave.

The individuals could be notified, for instance, by presenting to each recipient individual logged onto the system a notice indicating that an excursion should be created. The notice could additionally allow the individual to view a proposed excursion notice. The notice could employ GUI elements such as those discussed above with reference to notifications produced by the BRPD handler module. For various embodiments of the invention, the individual could be required to submit an electronic signature in order to view the proposed excursion notice. An individual could provide permission to create the notice, for example, by submitting an electronic signature. This might be executed via GUI elements. Rules, perhaps included in the above-noted specification, could state which electronic signatures the excursion handler module needed to be collect before it could create the excursion report. In various embodiments of the present invention, the excursion handler module, having received such electronic signatures, could, add them to the excursion notice upon the notice's creation.

After creation of the excursion notice, the excursion handler module could notify appropriate individuals of the notice's creation (step 203) and the notification could allow each recipient to view the excursion notice. A recipient might need to submit an electronic signature in order to view the excursion notice. An indication of the personnel to be notified could, for instance, found in an accessible store.

In various embodiments of the invention, individuals receiving notification that an excursion report had been created might need to confirm receipt of the notification. Receipt might be confirmed by submission of an electronic signature to the excursion handler module (step 205). In various embodiments of the present invention, the excursion handler module could add such received confirmations and/or electronic signatures to the excursion notice.

In certain embodiments of the present invention, among the individuals receiving notification that an excursion report had been created could one or more individuals having the authority to approve the excursion report. Such an individual could be, for example, a microbiology department manager or designee thereof. The above-noted indication of personnel to be notified could specify which of those individuals had authority to approve excursion reports.

Accordingly, as a next step, the excursion handler module could await receipt from an authorized individual of approval or disapproval of the excursion notice (step 207). An authorized individual might submit such an approval or disapproval, for example, by indicating approval or disapproval using a GUI. An electronic signature might be submitted along with the indication. The excursion handler module could add such received approvals or disapprovals, and/or electronic signatures to the excursion notice. In certain embodiments, the excursion handler module might consider the excursion notice to be non-approved in the case where approval was not received in a predetermined period of time.

Next, the excursion handler module could take steps to close the excursion notice (step 209). Such closure could, for example, be performed in a way similar to that described above. In the case where the excursion was approved, the excursion handler module might next pass the excursion to the BRPD handler module for inclusion in the batch record corresponding to the batch product for which the excursion was created.

Behavior of an EMCAR handler module will now be discussed with reference to FIG. 3.

Upon receiving notification from an EC program module that an EMCAR should be created with regard to the production of a particular batch product, an EMCAR handler module could act to create an EMCAR (step 301). More generally, the EMCAR handler module could create an EMCAR in response to a discrepancy such as, for example, a developing trend. The EMCAR handler module could learn of such a trend, for instance, via equipment, data entry and/or notification by an employee, and/or other program modules. An employee might, for example, execute such data entry and/or notification using a GUI, perhaps also submitting an electronic signature.

EMCAR creation could be performed in a manner similar to that described above with reference to the excursion handler module. Included in the created EMCAR could be, for example, details of the type of assessment, location where the action limit was exceeded, and/or the date/time when the action limit was exceeded.

For various embodiments of the present invention, the EMCAR handler module might not automatically create an EMCAR upon notification that an action limit was exceeded. Instead, in a manner similar perhaps to that described above with reference to the excursion handler module, the EMCAR handler module could advise one or more individuals that an EMCAR should be created. Among these individuals could be, for instance, a microbiology analyst. The one or more individuals could provide the EMCAR handler module permission to create a notice in a manner similar to that described above. Accordingly, the one or more individuals might provide electronic signatures signifying permission to create an EMCAR, perhaps employing GUI elements to do so. The EMCAR handler module, having received such electronic signatures, could, add them to the EMCAR upon the EMCAR's creation.

After creation of the EMCAR, the EMCAR handler module might act to notify appropriate individuals of this fact (step 303). This could be executed in a manner similar to that described above. An indication of the personnel to be notified could, for instance, be included in an accessible store.

In various embodiments of the invention, individuals receiving notification that an EMCAR had been created might need to confirm receipt of the notification. Receipt might be confirmed, for example, by submission of an electronic signature (step 305). In various embodiments of the present invention, the EMCAR handler module could add such received confirmations and/or electronic signatures to the EMCAR.

Next, the EMCAR handler module could take steps to facilitate investigation and action by one or more individuals regarding the EMCAR. The one or more individuals could be those notified in step 303, and could perform investigation and/or other action in response to that notification.

Investigation corresponding to an EMCAR could include, for instance, review of documentation (e.g., maintenance documentation), inherent physical and operational parameters, and/or training status of personnel involved in manufacture of the corresponding batch product. Such investigation might also include identification of a microbial contaminant and/or its possible source. More generally, such investigation might seek to identify root causes and/or to identify corrective actions to take. Individuals involved in the investigation process could provide data regarding to the process to the EMCAR handler module. Such data could be provided via a GUI in a manner similar to that discussed above, and the individuals might further provide one or more electronic signatures.

Data regarding the investigation process could be provided to the EMCAR handler module in other ways as well. For instance, equipment involved in the investigation process could provide data regarding their operations to the EMCAR handler module. Such data might be communicated using simple object access protocol (SOAP), remote method invocation (RMI), Java messaging service (JMS), or the like. An individual involved with the operation of such a piece of equipment might provide an electronic signature and/or additional data for dispatch to the EMCAR module along with the data provided by the piece of equipment. The individual might enter the additional data and/or electronic signature through use of a GUI as discussed above.

The EMCAR handler module could act to add to the EMCAR received data and/or electronic signatures regarding the investigation (step 307).

Perhaps making use of information yielded by the investigation, one or more individuals might come up with a course of action to address the issues associated with EMCAR. One or more of these individuals could provide to the EMCAR handler module information regarding the intended course of action, perhaps along with one or more electronic signatures. Also provided to the EMCAR handler module by one or more individuals, perhaps along with one or more electronic signatures, could be information regarding the implementation of the course of action. Various pieces of equipment involved in the implementation might also provide data to the EMCAR handler module. This could be performed in a manner similar to that just described. In a manner also similar to that just described, one or more individuals involved with the operation of such equipment might provide electronic signatures and/or additional data to the EMCAR handler module.

After implementing the course of action, one or more individuals might, perhaps along with one or more electronic signatures, provide follow-up information and/or attachments to the EMCAR handler module. The EMCAR handler module might also receive follow-up information and/or attachments from equipment and/or individuals operating the equipment. The EMCAR handler module could act to add to the EMCAR such received data and/or electronic signatures regarding the course of action (step 309).

Having implemented the course of action, one or more individuals might act to assess the impact of the course of action. Such assessment could involve, for instance, assessment of impact of product safety, quality, identity, purity, and potency (SQuIPP). Also performed could be assessment of the location where an action limit associated with the EMCAR occurred.

In a manner similar to that just described with regard to investigation, the EMCAR handler module could receive, from one or more individuals, equipment, and/or the like, data corresponding to the assessment. The one or more individuals might additionally provide one or more electronic signatures. The EMCAR handler module could act to add to the EMCAR such received items (step 311).

In various embodiments of the present invention, it might be determined during the assessment process that a stability assessment hold should be placed on a patch product associated with the EMCAR. An indication of such a determination might be received by the EMCAR handler module along with the above-mentioned received data and/or electronic signatures. Upon receipt of such an indication, the EMCAR handler could add it to the EMCAR.

As a next step, the EMCAR handler module could inform one or more individuals of a need to approve or disapprove the EMCAR. The one or more individuals to be notified could be specified in a store accessible by the EMCAR handler module. The EMCAR handler module could then await receipt of approval or disapproval of the EMCAR (step 313). Along with such approval or disapproval could be one or more electronic signatures. The EMCAR handler module next could add received approvals or disapprovals, and/or electronic signatures to the EMCAR. As was the case for the excursion handler module, in certain embodiments, the EMCAR handler module might consider the EMCAR to be non-approved in the case where approval was not received in a predetermined period of time.

Next, the excursion handler module could take steps to close the excursion notice (step 315). Such closure could, for example, be performed in a way similar to that described above. In the case where the EMCAR was approved, the EMCAR handler module might next pass the EMCAR to the BRPD handler module for inclusion in the batch record corresponding to the batch product for which the excursion was created.

Upon receiving the EMCAR, the BRPD handler module might search the EMCAR for indication that a batch product stability assessment hold should be placed. In the case where the BRPD handler module discovered such a hold, the BRPD handler module could institute the hold.

Deviation Events

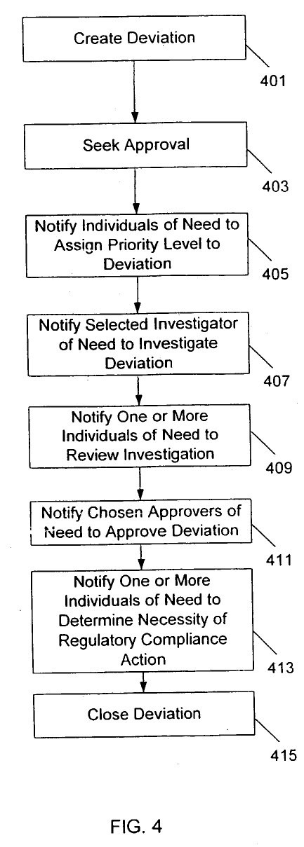

Various embodiments of the present invention may employ a deviation handler software module that deals with deviation events. Operation of such a module will now be discussed with reference to FIG. 4.

A deviation handler module might act to create a deviation (step 401) upon receiving a request to do so from one or more appropriate individuals. The deviation handler module might have and/or have access to an indication of what individual had the power to submit such a request. The request, perhaps along with certain details of the deviation, could be provided to the deviation handler module by an individual, for example, via a GUI. Submitted along with the request could be one or more electronic signatures. Such a request could be submitted, for instance, in response to the occurrence of an unusual event that was believed to have a possible impact on product SQuIPP and/or believed to possibly affect a critical point in the manufacture of a particular batch product. Upon creation of the deviation, the deviation handler module could add to it any received details and/or electronic signatures.

After creating the deviation, the deviation handler module could take steps to have it approved by one or more appropriate individuals (step 403). The deviation handler module might consult an accessible store to learn of the appropriate individual or individuals. The appropriate individual or individuals might, for example, be associated with a quality assurance team. The deviation handler module could next notify the appropriate individuals of a need to approve the deviation. This could be performed in a manner analogous to that described above with reference to other modules. Accordingly, such an individual logged onto the system might receive and indication that approval was needed, and might be able to employ a GUI to view the deviation.

The individual could next review the deviation, performing tasks such as checking included data for accuracy. The individual might be able to make corrections to the deviation, perhaps submitting an electronic signature along with such deviations. After review and any corrections, the individual could submit approval or disapproval of the deviation to the deviation handler module, perhaps along with an electronic signature. The approval, corrections, and/or electronic signature could be submitted in a manner analogous to that described above with reference to other modules. Upon receipt of the approval, disapproval, corrections, and/or electronic signature, the deviation handler module could add these elements to the deviation.

Next, the deviation handler module could notify one or more appropriate individuals of a need to assign a priority level to the deviation (step 405). The deviation handler module could further specify in the notification a need to assign an investigator to the deviation, and/or may specify a need to select a support group to aid in the investigation. The individual to which the notification could be sent could be specified by an accessible store. The individual could be, for instance, a deviation investigation unit (DIU) manager.

In response, the one or more appropriate individuals could submit to the deviation handler module the selected priority level, investigator, and/or support group. In the case where the one or more individuals determined that a stability check hold should be placed on the corresponding batch product, an indication of this could also be forwarded to the deviation handler module. The deviation handler module could add the received items to the deviation.

Next, the deviation handler module could notify the selected investigator of a need to investigate the deviation (step 407). In the case where a support group was chosen, notification may be sent to the corresponding individuals as well. In the investigation process, the investigator, and perhaps any support group, could act, for instance, to determine root causes, corrective actions, and to assess impact. Record of these actions, and perhaps also one or more electronic signatures, could be forwarded to the deviation handler module. Upon receipt, the deviation handler module could add these items to the deviation.

Next, the deviation handler module could notify the one or more individuals that assigned the investigator of a need to review the investigation, of a need to determine necessity of a batch product stability hold, and/or of a need to assign approvers (step 409). In response, the one or more individuals could perform the specified actions. The one or more individuals could send to the deviation handler module indication of the selected approvers, indication if a stability hold was required, and/or evidence of the review, perhaps including one or more electronic signatures. The deviation handler module could add the received items to the deviation. Upon later receipt of the deviation, the BRPD handler module might search the deviation for indication that a batch product stability assessment hold should be placed. As discussed above, in the case where the BRPD hander module discovered such a hold, the BRPD handler module could institute the hold.

As a next step, the deviation handler could notify the chosen approvers of the need to approve the deviation (step 411). The individuals could respond by indicating approval or disapproval, perhaps including one or more electronic signatures. The deviation handler module could add the received items to the deviation.

Next, the deviation handler module could notify one or more appropriate individuals of a need to determine if regulatory compliance action was required with respect to the deviation (step 413). The individual to which the notification could be sent could be specified by an accessible store. In response, the individuals could determine if regulatory compliance action was required. In the case where no action was required, the individuals could submit an indication of this to the deviation handler module, perhaps including one or more electronic signatures. In the case where it was determined that action was required, the individuals could act to have the required tasks performed. The individuals could then submit to the deviation handler module data relating to the tasks performed and/or an indication that regulatory action was required, perhaps also including one or more electronic signatures. The deviation handler module could add the received items to the deviation.

In certain embodiments, in the case where it was determined that regulatory action was required, the individuals might notify the deviation handler module that regulatory compliance action was needed, and that data concerning this action was pending. Included with this submission could be one or more electronic signatures. The individuals could at a later time forward to the deviation handler module data relating to the tasks performed, and perhaps one or more electronic signatures. As before, the deviation handler module could add the received items to the deviation.

Next, the deviation handler module could take steps to close the deviation (step 415). Such closure could, for example, be performed in a way similar to that described above. In the case where the deviation was approved, the deviation handler module might next pass the deviation to the BRPD handler module for inclusion in the batch record corresponding to the batch product for which the deviation was created.

Planned Process Modifications Events

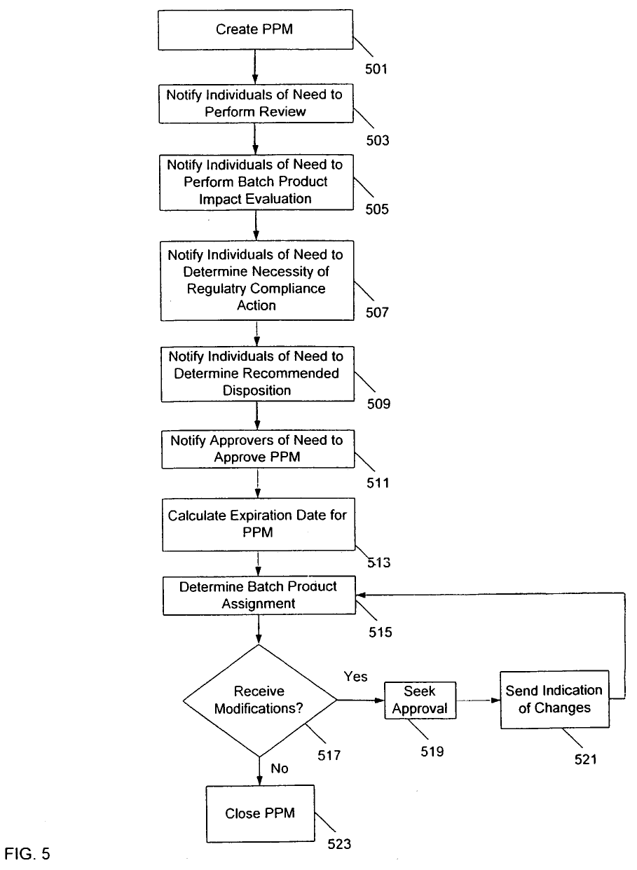

With reference to FIG. 5, it is noted that various embodiments of the present invention may employ a planned process modification handler software module that facilitates various actions related to planned process modifications.

A planned process modification (PPM) may be used to describe one or more planned temporary modifications to an MPR, SOP, and/or other controlled document. More generally, a PPM may be used to describe one or more planned temporary changes to, for instance, procedures, production techniques, quality controls, equipment, facilities, personnel, labeling, and/or the like as established by one or more controlled documents.

One or more individuals, perhaps associated with one or more departments, wishing to instantiate a PPM may send to a Planned Process Modification (PPM) module an indication of this desire. Included with the indication may be data relating to the proposed PPM such as indications, descriptions, and/or justifications of modifications to one or more specified controlled documents. Also included may be one or more electronic signatures. Upon receipt of such items, the PPM handler module may take steps to create a PPM (step 501) and add to it the received items.

Next, the PPM handler may notify one or more individuals of a need to perform an initial review of the PPM, and perhaps of a need to define support groups to aid them in performing a batch product impact evaluation with regard to the modifications proposed by the PPM (step 503). The one or more individuals notified might be specified in a store accessible by the PPM handler module and might include, for instance, individuals acting as quality representatives. After performing the initial review, the one or more individuals could provide a record of this review to the PPM handler module, perhaps including one or more electronic signatures. The one or more individuals may also provide to the PPM handler module a specification of chosen support group members. The PPM handler module could add the received items to the PPM.

Next, the PPM handler module could notify one or more individuals of a need to perform batch product impact evaluation with regard to the PPM (step 505). The one or more individuals could include, for instance, the one or more individuals notified to perform an initial review of the PPM and perhaps also one or more individuals of chosen to comprise a support group. Further notified could be one or more additional individuals. The one or more additional individuals might be specified in a store accessible by the PPM handler module and might include, for instance, individuals acting as technical operations (tech-ops) staff members. After performing batch product impact review, the one or more notified individuals could provide a record of the review to the PPM handler module, perhaps including one or more electronic signatures. The PPM handler module could add the received items to the PPM.

As a next step, the PPM handler module could, perhaps in a manner similar to that described above with reference to the deviation handler module, notify one or more appropriate individuals of a need to determine if regulatory compliance action was required with respect to the deviation (step 507). The one or more individuals might be specified in a store accessible by the PPM handler module and might include, for instance, licensing compliance staff members.

In response the individuals could, perhaps in a manner similar to that described above with reference to the deviation handler module, act to determine if regulatory compliance action was required. In the case where no action was required, the individuals could submit an indication of this to the PPM handler module, perhaps including one or more electronic signatures. In the case where it was determined that action was required, the individuals could act to have the required tasks performed. The individuals could then submit to the deviation handler module data relating to the tasks performed and/or an indication that regulatory action was required, perhaps also including one or more electronic signatures. The deviation handler module could add the received items to the deviation.

In certain embodiments, in the case where it was determined that regulatory action was required, the individuals might notify the PPM handler module that regulatory compliance action was needed, and that data concerning this action was pending. Included with this submission could be one or more electronic signatures. The individuals could at a later time forward to the PPM handler module data relating to the tasks performed, and perhaps one or more electronic signatures. The PPM handler module could add the received items to the deviation.

Next, the PPM handler module could notify one or more individuals of a need to determine a recommended disposition for batch products associated with the PPM, of a need to determine release criteria for batch products associated with the PPM, and/or of a need to assign approvers for the PPM (step 509). The one or more individuals might be specified in a store accessible by the PPM handler module and might include, for instance, individuals acting as quality representatives.

In response, the one or more individuals could perform the requested actions. The one or more individuals could then send to the PPM handler module a recommended disposition, quality release criteria, and/or an indication of selected approvers, perhaps including one or more electronic signatures. A recommended disposition could be, for example, “release” or “quarantine.” The PPM handler module could add the received items to the PPM. Upon later receipt of the PPM, the BRPD handler module might search the PPM for indications relating to recommended disposition and/or product release criteria. Upon finding such indications, the BRPD handler module could act to place one or more appropriate holds on a batch product associated with the PPM.

As a next step, the PPM handler could notify the chosen approvers of the need to approve the PPM (step 511). The individuals could respond by indicating approval or disapproval, perhaps including one or more electronic signatures. The PPM handler module could add the received items to the PPM. After this, the PPM handler module could calculate an expiration date for the PPM (step 513). The calculation could, for example, take into account data received by the PPM module from the one or more individuals that initiated creation of the PPM. The PPM handler module might then take action to have the PPM printed for inclusion in a master document record and/or other record.

As a next step, the PPM handler module could act during the time period before the expiration of the PPM to determine batch products to which the PPM should be assigned (step 515). Such batch products could, for instance, be ones associated with batch records containing and/or linked to controlled documents for which the PPM specifies temporary modification.

In certain embodiments, the PPM handler module might not act to determine batch products to which the PPM should be assigned. Instead, the PPM handler module could notify one or more individuals of a need to perform this task. The one or more individuals might be specified in a store accessible by the PPM handler module and might include, for instance, individuals acting as manufacturing department employees. The one or more individuals could then provide to the PPM handler modules one or more specifications of batch products with which the PPM should be associated. Included with the specifications may be one or more electronic signatures. Upon receipt of the items, the PPM handler may act to add them to the PPM.

As a next step, the PPM handler module may await receipt of modifications to the PPM (step 517). In the case where no modification was received in a certain period of time, the PPM might terminate waiting for modifications and proceed to step 523.

Received modifications could be sent to the PPM handler by one or more individuals and could include, for instance, changes to PPM expiration date, contents, recommended disposition, release criteria, and/or the like. Included with such modifications might be a specification that the modifications must be approved. Also included with the modifications may be one or more electronic signatures. Upon receiving the items, the PPM handler module may act to add them to the PPM.

In the case where it is not indicated that approval is required, the PPM handler module may next act to make the specified changes to the PPM. In the case where it is indicated that approval is required, the PPM handier may seek approval from appropriate individuals before making the changes (step 519). Accordingly, the PPM handler might notify one or more individuals of a need to approve the changes. The one or more individuals could respond with approval or disapproval, perhaps including one or more electronic signatures. The PPM handler module could add the received items to the PPM, and could make the changes in the case where approval was received. The one or more notified individuals could be, for instance, the one or more individuals that originally approved the PPM.

The PPM handler module might next send to one or more individuals indication of whether or not changes were made to the PPM (step 521). The one or more individuals could be specified in an accessible store and could include, for instance, the one or more individuals that originally approved the PPM, individuals that submitted modifications, and/or individuals associated with a document control department. After this, the PPM handler module could return to step 515.

Upon reaching a determination in step 517 that no modifications or no additional modifications would be received, the PPM handler module could take steps to close the PPM (step 523). Such closure could, for example, be performed in a way similar to that described above. In the case where the PPM was approved, the PPM handler module could next pass the PPM to the BRPD handler module for inclusion in the batch records to which it was determined that the PPM should be assigned.

Upon receipt of the PPM, the BRPD handler module might search the PPM for indications relating to recommended disposition and/or product release criteria. Upon finding such indications, the BRPD handler module could act to place one or more appropriate holds on a batch product associated with the PPM. For instance, in the case where the recommended disposition is “quarantine”, the BRPD handler module might place a hold on the appropriate batch product to be released when the received product release criteria is met.

During the flow just described, the PPM handler module might await indication that a stability assessment hold should be placed on batch products associated with the PPM. The indication could be dispatched by one or more individuals, and could include one or more electronic signatures. Upon receipt of the items, the PPM handler module could add them to the PPM. Upon receipt of the PPM, the BRPD handler module might search the PPM for indication that a batch product stability assessment hold should be placed. As discussed above, in the case where the BRPD handler module discovered such a hold, the BRPD handler module could institute the hold.

It is further noted that for various embodiments of the present invention, during the flow just described, the PPM handler module might monitor for requests to cancel the PPM, requests to reset a status associated with the PPM, and/or inquiries regarding the PPM. Included with such requests may be one or more authorized signatures.

Upon receiving such a request or inquiry, the PPM handier module might first determine of the individual submitting the request was authorized to do so. The PPM handler module might achieve this, for instance, by comparing the identity of the individual submitting the request or query with an accessible store indicating those authorized to do so. The identity of the individual could, for instance, be determined by consulting an attached electronic signature. Having determined that a request or inquiry was sent by an authorized individual, the PPM handler could take action to comply with the query or request.

For example, in the case of a request to cancel the PPM, the PPM handler module could act to disassociate from the PPM any batch products that were associated with the PPM, to stop associating further batch products with the PPM, to add to the PPM an indication that the PPM was cancelled, and/or to close the PPM.

As another example, in the case of an inquiry regarding the PPM, the PPM handler module could extract from the PPM the information necessary to answer the inquiry.

Comment Events

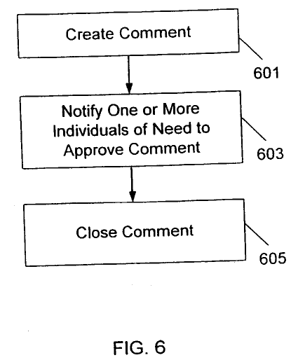

With reference to FIG. 6 it is noted that various embodiments of the present invention may employ a comment handler software module that facilitates various actions related to comments. A comment might be created in response to an unusual occurrence take takes place during the production of a particular batch product in the case where the occurrence is not believed to have an impact on batch product SQuIPP.

A comment handler module might act to create a comment (step 601) upon receiving a request to do so from one or more appropriate individuals. Included with the request could details and/or data corresponding to the event. Also included with the request could be one or more electronic signatures. The deviation handler module might determine if the one or individuals requesting the creation of the comment had authority to do so by consulting an accessible store specifying the individuals possessing such power. Upon creation of the comment, the deviation handler module could add to it any received details, data and/or electronic signatures.

After creating the comment, the comment handler module could notify one or more appropriate individuals of a need to approve the comment (step 603). The comment handler module might know of the appropriate individual or individuals, for instance, by consulting an accessible store. The appropriate individual or individuals might, for example, be associated with a quality assurance team.

The notified individuals could perform tasks such as checking the comment for data accuracy and then provide the comment handler module with approval or disapproval of the comment. Included with the approval could be details relating to the approval and/or one or more electronic signatures. Upon receipt of the approval, disapproval, corrections, and/or electronic signature, the comment handler module could add these elements to the comment.

Next, the comment handler module could take steps to close the comment (step 605). In the case where the comment was approved, the comment handler module might next pass the comment to the BRPD handler module for inclusion in the batch record corresponding to the batch product for which the comment was created.

Supplement Events

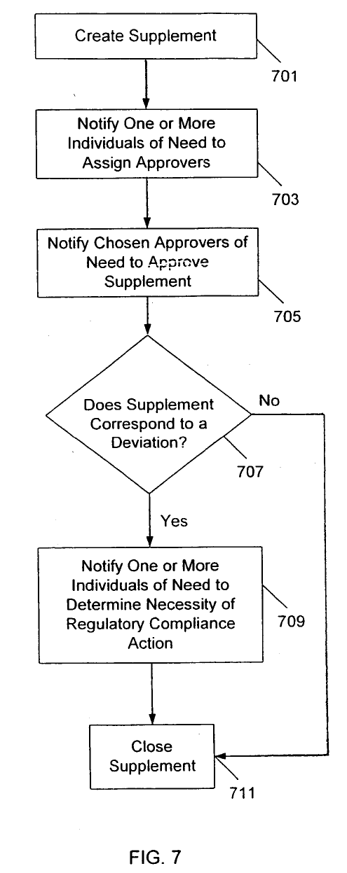

Various embodiments of the present invention may allow for the use of supplements. A supplement may be used to provide additional information corresponding to a deviation, EMCAR, comment, PPM, excursion notice, or the like. Such additional information could act, for instance, to add support, clarification, and/or the like. With reference to FIG. 7 it is noted that various embodiments of the present invention may employ a supplement handler software module that facilitates various actions related to supplements.

A supplement handler module might act to create a supplement upon receiving a request to do so from one or more appropriate individuals (step 701). Included with the request could be details and/or data corresponding to the supplement. Among such details and/or data could be, for instance, a description of the supplement, a stated reason for requesting the supplement, and/or a supplement issue date. Also included may be one or more electronic signatures and/or an identification of the deviation, EMCAR, comment, PPM, excursion notice, or the like to which the supplement is to correspond.

The supplement handler module might determine if the one or individuals requesting the creation of the supplement had authority to do so by consulting an accessible store noting the individuals possessing such power. Upon creation of the supplement, the supplement handler module could add to it any received details, data and/or electronic signatures.

After creating the supplement, the supplement handler module could notify one or more individuals of a need to assign approvers for the supplement (step 703). The one or more individuals to notify could, perhaps, be specified by a store accessible by the supplement handler module. In response, the one or more individuals could select individuals to approve the supplement and indicate the selected individuals to the supplement handler module. Included with the information may be one or more electronic signatures. The supplement handler module could add the received items to the supplement.

As a next step, the supplement handler could notify the chosen approvers of the need to approve the supplement (step 705). The individuals could respond by indicating approval or disapproval, perhaps including one or more electronic signatures. The supplement handler module could add the received items to the supplement.

In the case where the supplement does not correspond to a deviation, in step 707 the supplement handler module may jump to step 711. In the case where the supplement does correspond to a deviation in step 707, the supplement handler module may notify one or more appropriate individuals of a need to determine if regulatory compliance action was required with respect to the supplement (step 709). The one or more individuals to which the notification could be sent could be specified by an accessible store.

In response, the individuals could determine if regulatory compliance action was required. In the case where no action was required, the individuals could submit an indication of this to the supplement handler module, perhaps including one or more electronic signatures. In the case where it was determined that action was required, the individuals could act to have the required tasks performed. The individuals could then submit to the supplement handler module data relating to the tasks performed and/or an indication that regulatory action was required, perhaps also including one or more electronic signatures. The supplement handler module could add the received items to the supplement.

In certain embodiments, in the case where it was determined that regulatory action was required, the individuals might notify the supplement handler module that regulatory compliance action was needed, and that data concerning this action was pending. Included with this submission could be one or more electronic signatures. The individuals could at a later time forward to the supplement handler module data relating to the tasks performed, and perhaps one or more electronic signatures. The supplement handler module could add the received items to the supplement.

As a next step, the supplement handler module could take steps to close the supplement (step 711). In the case where the supplement was approved, the supplement handler module might next act to add the supplement to the specified deviation, EMCAR, comment, PPM, excursion notice, or the like. For certain embodiments, in the case where the supplement handler module determines that the specified deviation, EMCAR, comment, PPM, excursion notice, or the like has already been added to one or more batch records, the supplement handler module could instruct the BRPD handler module to add the supplement to those batch records.

Hardware and Software

Certain procedures and the like described herein may be executed by or with the help of computers. The phrases “computer”, “general purpose computer”, and the like, as used herein, refer, but are not limited to, a processor card smart card, a media device, a personal computer, an engineering workstation, a PC, a Macintosh, a PDA, a wired or wireless terminal, a server, or the like, perhaps running an operating system such as OS X, Linux, Darwin, HP-UX, Windows CE, Windows NT, Windows 2000, Windows XP, Palm OS, Symbian OS, or the like, perhaps with support for Java or .Net.

As noted above, various aspects of the present invention involve the notification of one or more individuals. Such functionality may be implemented in a number of ways. For instance, a notification could be sent, perhaps employing JMS, RMI, SOAP, or the like, to a notification handler module that maintained notifications for one or more individuals.

Accordingly, such an individual, appropriately logged in via a computer, terminal, or the like, could be presented with a GUI dialog box or the like providing information regarding the notification via action of the notification module. Providing information regarding the notice could entail for instance, allowing viewing of a data structure (e.g., an excursion notice or EMCAR) to be approved.

The dialog box or the like could additionally provide GUI elements for responding to the notice. The GUI elements could include, for example, editable fields and one or more electronic signature panels. Data relating to the response could be dispatched to the appropriate software module using JMS, RMI, SOAP, or the like. An individual might, for various embodiments of the present, need to consult an assigned inbox in order to view the notice. Such an inbox could be accessible via GUI elements provided by the computer, terminal, or the like to which the individual had logged in. In certain embodiments of the present invention, an individual could receive an indication that she should log-in to the system in order to view a waiting notification. Such an indication could be dispatched, for example, via email, pager, audible signal, visual signal, telephone call, or the like.

Various aspects of the present invention involve one or more individuals submitting a request, information, or the like to one or more software modules. Such functionality may be implemented in a number of ways. For instance an individual, appropriately logged in via a computer, terminal, or the like, could employ one or more GUI elements to articulate the request. Such GUI elements could include those described above with reference to notifications, and could include one or more editable fields and/or one or more electronic signature panels. In a manner similar to that discussed above with relation to notifications, data relating to the request or the like could be dispatched to the appropriate software module using JMS, RMI, SOAP, or the like.

Electronic signature functionality could be implemented in a manner compliant with 21 CFR part 11, which is incorporated herein by reference. Accordingly the signature panels and/or supporting infrastructure could be implemented so that, for instance, two distinct identification components (such as user identifier and password) would be required to execute an electronic signature, use of another's electronic signature would require the collaboration of two or more individuals, identification elements would be periodically checked, revised, and recalled, and/or attempts at unauthorized use of electronic signatures would be detected and reported to a security unit or the like.

Furthermore, electronic signature functionality could be implemented so as to produce electronic signatures that each included the printed name of the signer, the data and time of signature execution, and/or the meaning of the signature (e.g., review or approve). Electronic signature functionality might be implemented so that each electronic signature was unique to an individual and never reassigned to another individual.

For various embodiments of the present invention, electronic signature functionality could be implemented in a manner that employed biometric techniques. Such biometric techniques might, for example, entail rental, iris, fingerprint, handwriting, facial, voice, heat pattern, typing rhythm, full-hand geometry, and/or earlobe geometry scanning and/or recognition techniques. Implementation of such functionality might make use of various techniques known in the art.

As discussed above, various aspects of the present invention involve the creation of, and addition of data to, data structures such as batch records, EMCARs, and the like. Such data structures could, for instance, be created as new records in a database using techniques known in the art. Such a database could be, for instance, a structured query language (SQL) database such as an Oracle database. Alternately, such data structures could be created as new files in a filesystem using techniques known in the art. Such a file system could be, for instance, an NTFS or XFS filesystem.

Data could be added to such data structures using techniques known in the art. In certain embodiments of the present invention, data to be added to a data structure could be linked to that data structure instead of being actually added to it. Closure of such data structures could be performed in a number of ways. For instance, a flag associated with the data structure could be appropriately set. As a specific example, a “CLOSED” flag associated with the data structure might be set to Boolean true.

As noted above, various aspects of the present invention involve consulting an accessible store. This might be achieved, for instance, by accessing a database such as an SQL database using techniques known in the art. Such might also be achieved, for instance, by querying an appropriate software module, perhaps via SOAP, RMI, JMS, or the like. As discussed above, under various circumstances a software module might consult an accessible store or the like in order to determine if one or more individuals making a request, providing information, or the like had authority to do so. For such circumstances, the module might, for instance, know the identities of those submitting the request, information, or the like via one or more electronic signatures included with the request, information, or the like.

In various embodiments of the present invention, one or more audit trails may be maintained. Such an audit trail might be kept with regard to data structure additions and/or changes of the sort just discussed, and may yield a complete and accurate history of additions and/or changes to the data structures, including indications of what additions and/or changes were made and indications of the individual or individuals responsible for each addition and/or change. More generally, one or more audit trails may be maintained with regard to all actions performed by each logged-in individual so as to yield a record of what actions were performed by each individual, and when such actions were performed.

Such an audit trail may exist separately from the above-noted data structures and/or might be integrated with such data structures. In certain embodiments, such an audit trail might exist in the same database, filesystem, or the like that holds one or more of the above-noted data structures. Alternately or additionally, a separate database, filesystem, or the like may be employed. It is further noted that such an audit trail could be implemented in a manner consistent with 21 CFR part 11. Accordingly, the audit trail might indicate the times of additions and/or provide a time-sequenced trail of such additions.

For various embodiments of the invention, a single database, filesystem, and/or the like could be employed to hold all data structures such as batch records, EMCARs, deviations, and the like, as well as components thereof such as electronic signatures, records of actions performed, manufacturing procedures, specifications, and the like. Alternately, multiple databases, filesystems, or the like may be employed. Various embodiments of the present invention may allow for the an item held by a database or the like to be marked as “inactivated”.

Accordingly, one of the above-noted software modules might, upon receiving from one or more authorized individuals a request to mark such an item as “inactivated”, add an appropriate identifier to the item. For instance, the software module might set an “inactivated” flag to Boolean true in an appropriate database record. The software module might confirm that the one or more individuals were authorized to make the request. This might be done, for instance, by consulting an accessible store indications individuals authorized to make the request.

Embodiments of the present invention may allow for the creation of complete copies of data structures such as batch records, EMCARs, and the like. For embodiments where one or more audit trails are maintained separately from such data structures, it may be possible to create complete copies of those audit trails.

Such complete copy functionality could be in compliance with 21 CFR part 11. The copies might be, for example, in electronic format or human-readable format, and might include printouts. In a related manner, various embodiments of the present invention may allow for the viewing of such data structures by authorized individuals. Such copying and viewing functionality may comprise functionality to allow for auditing by the Food and Drug Administration (FDA) or other regulatory body.

An individual could, according to various embodiments of the present invention, execute log-in by entering a user ID and password into a computer, terminal, and/or the like. Such entry might be performed by way of a GUI. Upon executing log-in, the individual could perform and/or experience various aspects of the present invention noted above such as receiving notifications and included data from software modules, and such as sending requests or the like to software modules. The user ID and password for an individual could be unique to that individual and never reassigned to anyone else. Furthermore, password expiration might be enforced whereby an individual might be required to periodically change her password. Depending on the embodiment, the user ID and password for an individual could the same as or different than a user ID and password associated with that individual's electronic signature.

For various embodiments of the invention, log-in by an individual might involve the user ID and password entered by the individual being dispatched to an authorization module. The authorization module might act to consult an accessible store in order to determine if the user ID and password corresponded to an individual having authority to perform log-in. Certain embodiments of the present invention may associate access privileges with individuals. Such access privileges could, for instance, define the operations that an individual is allowed to perform when logged in. For such embodiments, the authorization module might additionally consult an accessible store in order to determine the access privileges associated with a particular individual.

Various embodiments of the present invention may also provide functions such as note taking, online help, and ad-hoc query functions. Such functionality could be available to a logged-in user, for instance, via a GUI provided by the computer, terminal, or the like with which the individual executed log-in. Note taking functionality could be provided by one or more software modules and could allow a logged-in user to take personal notes. Online help functionality could allow a logged-in user to access one or more help files regarding performable operations or the like. Ad-hoc query could allow a logged-in individual to retrieve, view, and/or search data structures and/or other items stored in a database, filesystem, or the like, and/or handled by one or more software modules as discussed above. Access privileges of the sort noted above might define, for instance, the ad-hoc query functions that an individual was allowed to perform. Accordingly, access privileges might, for instance, limit the set of data structures for which the user could perform ad-hoc query functions.

In accordance with the present invention, a computer may run one or more software modules and/or additional software designed to perform one or more of the above-described operations, the modules and/or additional software being programmed using a language such as Java, Objective C, C, C#, C++, and/or the like according to methods known in the art. For various embodiments, communication between such modules could be achieved using technologies known in the art such as SOAP, RMI, and JMS.

It is noted that any described division of operations among particular software modules and/or additional software is for purposes of illustration, and that alternate divisions of operation may be employed. Accordingly, operations discussed as being performed by one software module and/or additional software item might instead be performed by a plurality of software modules and/or additional software. Similarly, operations discussed as being performed by a plurality of modules and/or additional software might instead be performed by a single module and/or additional software item.

Although embodiments of the invention may disclose certain software modules and/or additional software as operating on certain computers or the like, in alternate embodiments these modules might be distributed to run on other devices than those stated. As an example, operations disclosed as being performed by a particular computer or the like might instead be performed by a plurality of nodes and/or other devices. It is further noted that, in various embodiments, grid computing techniques may be employed.

For various embodiments of the present invention, an event handler module (e.g., an EMCAR handler module) may allow for reset and/or cancellation in the processing of a data structure (e.g., an EMCAR). Accordingly, upon receipt of a request to cancel processing of a data structure, an event handler module could stop processing of the data structure and add to it an indication that processing has been cancelled. Further, upon receipt of a request to reset processing of a data structure, an event handler module could return to an easier step in the processing flow for the data structure (e.g., the first step), and could add to the data structure an indication that processing has been reset. Such requests could be submitted by one or more authorized individuals in a manner similar to that discussed earlier, perhaps with the inclusion of one or more electronic signatures. Upon receiving such a request, an event handler module might take action to verify the authority of the one or more individuals to make the request. This might be achieved, for instance, by consulting an accessible store.

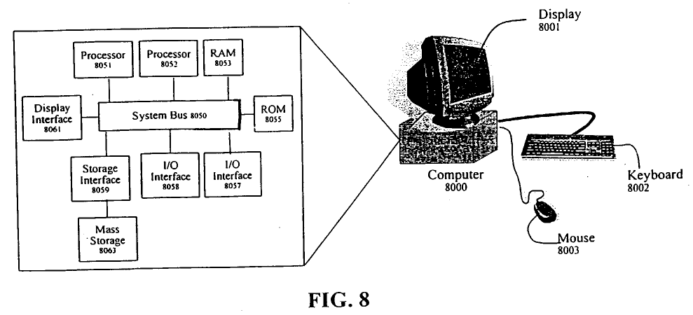

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 8000 as shown in FIG. 8 includes system bus 8050 which operatively connects two processors 8051 and 8052, random access memory (RAM) 8053, read-only memory (ROM) 8055, input output (I/O) interfaces 8057 and 8058, storage interface 8059, and display interface 8061. Storage interface 8059 in turn connects to mass storage 8063. Each of I/O interfaces 8057 and 8058 may be an Ethernet, IEEE 1394, IEEE 802.11b, Bluetooth, terrestrial video broadcast (DVB-T), satellite digital video broadcast (DVB-S), digital audio broadcast (DAB), GPRS, UMTS, or other interface known in the art.

Mass storage 8063 may be a hard drive, optical drive, or the like. Processors 8057 and 8058 may each be a commonly known processor such as an IBM or Motorola PowerPC, an AMD Athlon, an AMD Opteron, an Intel or Texas Instruments ARM, an Intel XScale, a Transmeta Crusoe, an Intel Pentium, or the like. Computer 8000 as shown in this example also includes an display unit 8001, a keyboard 8002 and a mouse 8003. In alternate embodiments, keyboard 8002, and/or mouse 8003 might be replaced with a touch screen, pen, keypad interface, and/or hardware and/or software allowing for voice interactivity. Computer 8000 may additionally include or be attached to card readers, DVD drives, or floppy disk drives whereby media containing program code may be inserted for the purpose of loading the code onto the computer. Furthermore, computer 8000 may additionally include one or more biometric interfaces such as retinal scanners and/or recognizers, fingerprint scanners and/or recognizers, or the like.

### EXAMPLE

### Athena II

A System Overview

A.1 Purpose

A purpose of the following is to discuss an “Athena II System” as a non-limiting example corresponding to various embodiments of the present invention. Athena II is a tool to track manufacturing procedure review and release, as well as tracking any issues that arise during the manufacturing process or otherwise impact product release. These issues include the following:

Deviations

Planned Process Modifications (PPM)

Environmental Monitoring Issues (EMCAR)

Change Controls

Validation Studies

Regulatory submissions related to any of the above

Review and release of related manufacturing procedures

Athena II provides a method of ensuring that all documents related to the release of product have been reviewed and found to be acceptable. This system will also provide evidence of procedure compliance to senior management and external entities. Athena II was built to accomplish objectives including:

Improved cGMP compliance, including transaction audit trail, electronic signature capability, controlled system security and validation documentation.

Provide an electronic system that tracks and maintains information regarding the status of each product throughout the manufacturing cycle. This provides quality assurance with access to all of the data that can impact product release decisions.

Improved capabilities to trend, monitor, and report the manufacturing product release process.

Reduce product release cycle times by improved issue tracking and resolution.

Built-in checks and balances to reduce human error.

Create a highly configurable system to reduce software maintenance and validation requirements as business rules change.

A.2 Example Organization

This example contains the following sections:

| | |
|---|---|
| Section A System | Describes exemplary purpose, scope, |
| Overview | organization, process flow and the IT |
| | Commissioning plan. |
| Section B System | Describes exemplary hardware, software interface |
| Requirements | and operating environment of the Athena II |
| | System. |
| Section C | Provides non-limiting definitions for terminology |
| Definitions & | and abbreviations used in this example |
| Abbreviations | |
| Section D | Identifies various references that have been used |
| References | in the creation of this example, or referenced by |
| | this document. Examples of references include, |
| | but are not limited to, SOPS, books, user manuals |
| | and regulatory guidance. |

A.3 System Flow/Functional Description

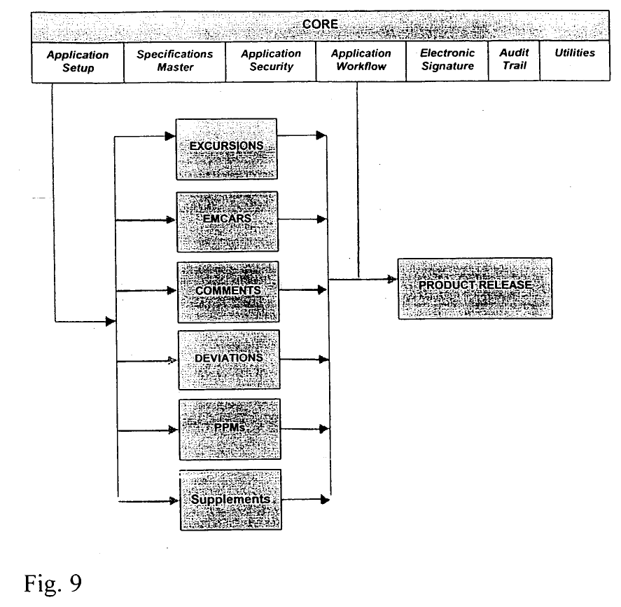

A conceptual overview of the exemplary Athena II system is shown in FIG. 9. A purpose of Athena II is to provide a computerized system to track the review process associated with Manufacturing Procedure batches and other documents that are part of the Batch Record, as well as identifying the disposition of each batch. This includes the capability to link issues (Deviations, Planned Process Modifications, or Environmental) to the batch as well as linking to other documents (batches) that are part of the Manufacturing Process. This system has also been developed in compliance with CFR 21 Part 11 for auditing and electronic signatures in a GMP environment.

The Athena II system was developed in a modular fashion, with each of the major manufacturing review process steps relating to a module in Athena II. The modules created were as follows:

Core

Excursions

EMCAR

Comments

Deviations

Planned Process Modifications (PPM)

Supplements

Product Disposition (Product Release)

Change Control—Included in Product Disposition

Validation Studies—Included in Product Disposition

A.3.1 Core

The operation of the Athena II Core module serves as the nucleus of the system. The following subsections provide a brief description for the functions performed by the Core module.

A.3.1.1 Application Setup

Application setup provides the capability to maintain codes and parameters that are used in the Athena II system. In addition to codes, the application setup subsystem also facilitates the maintenance of application messages and user interface preferences. The application setup subsystem is primarily maintained and administered by IT.

A.3.1.2 Specifications Master

The specification master represents all items that are entered and tracked in Athena II. Items would include Manufacturing Procedures (MPR) with associated materials, supporting procedures (i.e., appendix or MPR with out associated material), other documents (SOP, Programs, Specifications, etc.) and Equipment. The specification master subsystem setup is critical for the function of Athena II system. A Manufacturing Procedure will also have Work In Progress (WIP) information setup to identify and link the associated components. The components can be of any type mentioned above (MPR, supporting procedure, document, or Equipment). Each of the components is identified as mandatory or optional for the release of the batch. The WIP information plays a crucial role in the review, approval and release of a manufacturing procedure. The system also supports deactivating a specification to indicate that it is no longer in use.

A.3.1.3 Application Security

The Athena II system implements controlled security for gaining access to the system. Each user is identified by a user id and password. The user id and password is unique to each individual and cannot be reused by, or reassigned to, anyone else. Athena II enforces password expiration, thereby requiring users to change their passwords periodically. The security subsystem also controls user access to functions by establishing application roles. Application roles can then be granted to, or revoked from, the user to allow application function access. In addition to application roles, the Athena II database also maintains database roles to control the database object access. During application login, the system accepts the user id and password. For the user id and password accepted, the system determines the application role assigned and grants access privileges.

A.3.1.4 Application Workflow

Application Workflow supports the creation and routing of notifications in the system. Notifications are created to inform other system users about the occurrence of an event. The system creates such notifications and routes them to the appropriate users. Each user is assigned a Notification Inbox to facilitate the review of notifications received. In addition to notifications, the application workflow subsystem also provides the capability to route electronic records for critical functions such as review, approval etc. Each user involved in the routing process is able to review and electronically sign the record. The routing information and notification information is setup in the system for better customization and ease of use.

A.3.1.5 Electronic Signature

The Athena II system supports the execution of electronic signatures on electronic records. The electronic signature is authorized by the use of a user id and password. Each electronic signature is unique to an individual and is not reused by, or reassigned to, anyone else. Signed electronic records contain information about the a) Printed name of the signer, b) the date and time when the signature was executed, c) the meaning (such as review, approve) associated with the signature. Critical functions that require electronic signature can be identified and setup in the system.

A.3.1.6 Audit Trail

The Athena II system maintains an audit trail of all activities performed by each logged in user. The audit trail provides a record of essentially who did what, wrote what and when. All changes to existing records are recorded in the audit trail to maintain a complete and accurate history and to document individual responsibility. Audit trail data is available for inspection and review, and reports can be generated that describe the nature of the change and value(s) that were impacted (if any).

A.3.1.7 Utilities

The purpose of the Utilities subsystem is to provide notepad interface, online help and adhoc query/report building capabilities. Users will be able to write free form text from any of the functions in Athena II system. Adhoc query builder /report generator serves as the tool for easy retrieval of Athena II system data. The adhoc queries and reports produced can be saved for later use. The adhoc query/reporting tool is in addition to the standard reports produced by the Athena II system. The online help feature allows the system users to browse the user manual online.

A.3.2 Excursions

The Environment Control Program serves as an indicator of potential system problems before they adversely affect product quality. The Environment Control Program provides guidance on the monitoring methods, schedules, alert and action limits, and corrective action system utilized to monitor the environment for the suitability of aseptic and controlled area processing. The Environment Control Program is designed to determine the number and type of microorganisms associated with the preparation of the product. Air, surfaces, equipment, and product in process are monitored for microorganisms that may be associated with the product during the manufacturing process. If the environment control data exceeds the alert limit, microbiology initiates an Excursion Notice with details about the type of assessment, room, site location, date and time of sampling etc. and notifies the appropriate plant personnel. The recipients of an Excursion Notice are required to confirm receipt. The manager of microbiology (or designee) reviews the notice. Upon completion of review, the Excursion Notice is filed in the Microbiology department.

The Excursions functionality of the Athena II system facilitates the recording and tracking of Excursions, reduces paperwork by using automated documents, and allows for easy reporting.

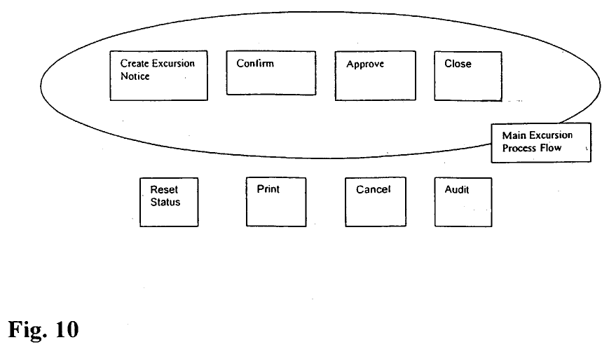

FIG. 10 diagram illustrates the high-level process flow of Excursions.

A.3.3 EMCAR

EMCARs provide a mechanism for documentation review and investigation when a discrepancy such as a developing trend occurs. The review includes, without limitation, a review of maintenance documentation, inherent physical and operational parameters, training status of personnel involved, identification of a microbial contaminant and its possible source. The microbiology analyst issues an EMCAR when the environmental monitoring result exceeds the established action limit. The test area's management implements appropriate corrective actions and the test site is retested via accelerated monitoring to assess the effectiveness of the corrective action. Microbiology management concludes the assessment of the area and assesses the impact on product safety, quality, identity, purity and potency (SQuIPP). The completed EMCAR report is then reviewed and filed in the Microbiology department With the use of the Athena II system, all of the information accrued during the process of initiating, confirming, investigating, assessing, approving and closing an EMCAR is captured. This allows the ability to track and monitor an EMCAR throughout its life cycle.

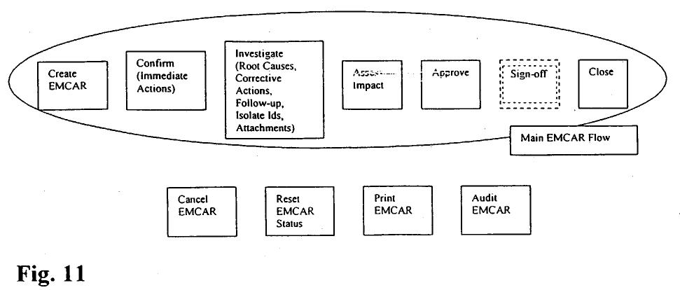

FIG. 11 illustrates the high-level process flow of EMCAR.

A.3.4 Comments

A comment is an unusual event that does not impact product SQuIPP. Any such comment has to be documented, processed, reviewed, and finally closed. Any department, which identifies an unusual event, may create a comment and work in conjunction with QA. This information is reviewed by QA to check for data accuracy. If there are no further issues to report, the comment is closed. Once a comment is closed, no further action is taken on the comment.

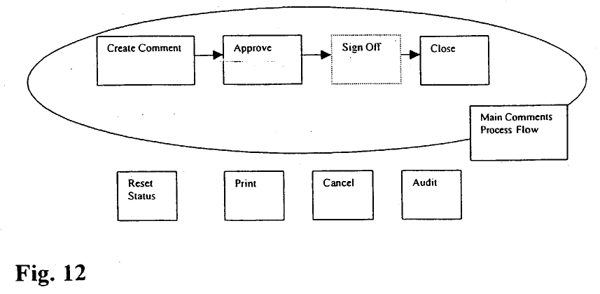

FIG. 12 illustrates the high-level process flow of Comment.

A.3.5 Deviations

A deviation is an unusual event that may impact product SQuIPP or may affect a critical point in a production process. Any such deviation has to be documented, processed, investigated, evaluated and finally closed. Any department, which identifies an unusual event, creates a deviation, in conjunction with Quality Assurance. This information is reviewed by Quality Assurance to check for data accuracy. The DIU manager assigns a priority level and an investigator to the deviation. Support groups are also assigned, if needed, to aid the investigator in his/her investigation. During the investigation process, the investigator determines the root causes, corrective actions and impact assessment. The DIU manager reviews the investigation process and assigns approvers for the deviation. If any of the impacted products require stability assessment, a stability check is marked as necessary before the release of the product. After the approvers approve the deviation, it is sent for licensing compliance evaluation. There it is decided if any regulatory action is needed for the deviation. If so, the necessary regulatory action is carried out and the deviation is finally printed and closed. Once a deviation is closed, no further action is taken on it.

The Deviations component of the Athena II system reduces product release cycle times by improving issue tracking and resolution. It also provides flexibility to selectively retrieve and view deviation information providing accurate documentation about the deviation process.

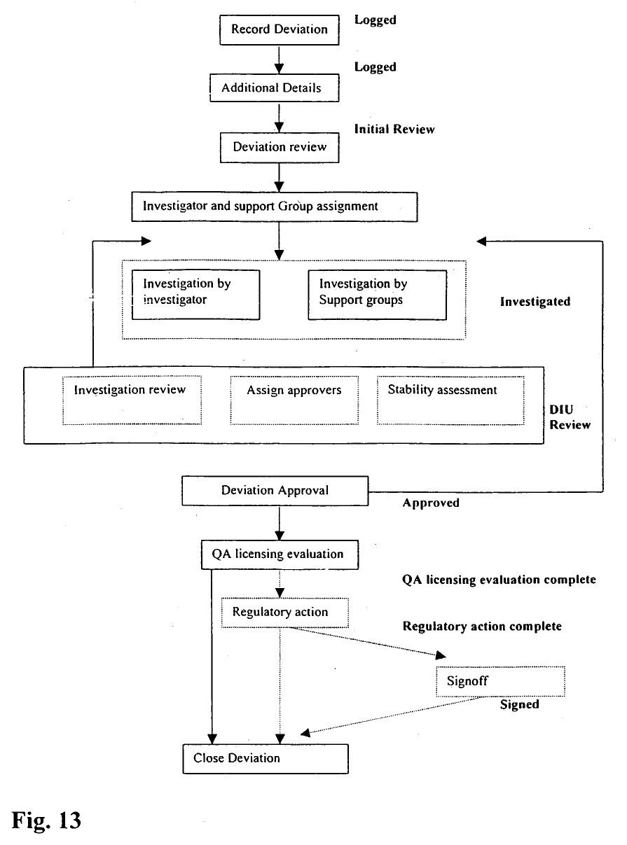

FIG. 13 illustrates the high-level process flow of Deviation.

A.3.6 Planned Process Modifications (PPM)

A PPM (Planned Process Modification) is used for all planned temporary modifications to procedures relating to the product, production process, quality controls, equipment facilities, responsible personnel and labeling as established by current controlled documents. A department may make an approved PPM to a Manufacturing Procedure, Standard Operating Procedure or any other controlled document as an interim or temporary device.

All PPMs must be documented, processed, evaluated, approved, assigned batches (if necessary), and finally closed. The originating department identifies, describes, and justifies the modifications to the document for the PPM. This information is reviewed by Quality Assurance to check for accuracy. The QA representative determines what support groups are required to aid in the evaluation. During the evaluation process, the Support groups determine the impact on products. At any point during the life cycle of the PPM, it may be determined that Stability assessment is required. The Product Disposition module will address stability notification and sampling requirements.

The Licensing Compliance Department then reviews the PPM to determine if any regulatory action is required. If regulatory action is required, the Regulatory Department determines the type of filing.

The QA representative determines the recommended product disposition and assigns approvers for the PPM. After the approval is completed, the system will calculate the PPM expiration date. The approved PPM is then printed for inclusion with the Master Document by Document Control.

For product related PPMs, Manufacturing will determine if the PPM will be used in the process and will assign the batch to the PPM. The system will prevent assignment of batches if the PPM is expired. Upon assignment to the PPM, batches will be automatically placed on hold. If the recommended product disposition is release, the hold will be automatically resolved. If the recommended product disposition is quarantine, Product Disposition will resolve the hold at a later time based on the criteria identified in the PPM.

If any modifications (Expiration date, text, or release criteria) are required to the PPM after approval, the QA representative will modify the PPM and identify whether approvers are required. Notifications will be sent to Document Control, original approvers and others as required.

Once the PPM is closed, no further action may be taken on the PPM. This module will also provide the functionality to cancel a PPM, reset the status for a PPM, and allow for inquiries on PPMs.

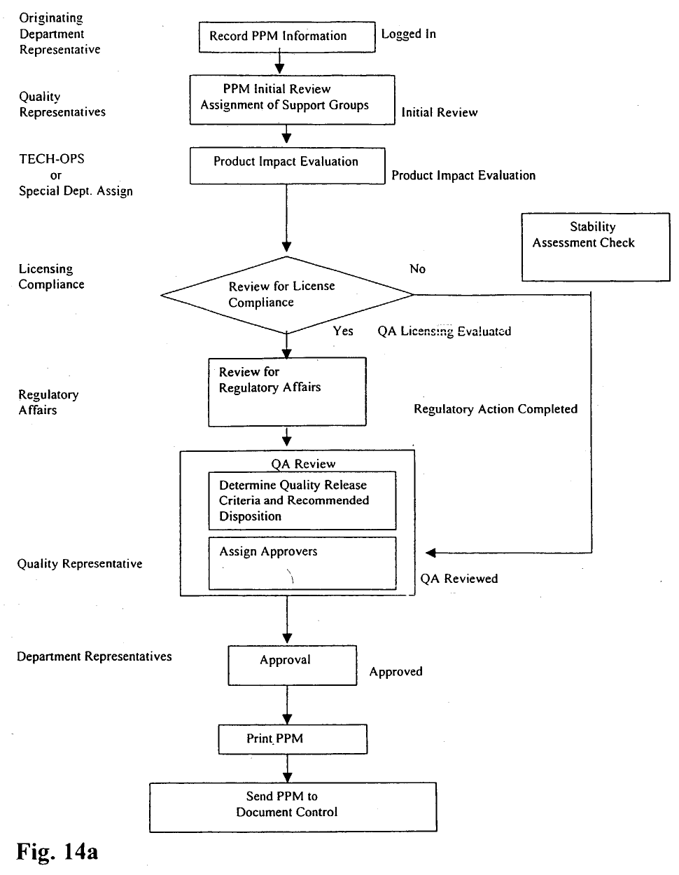

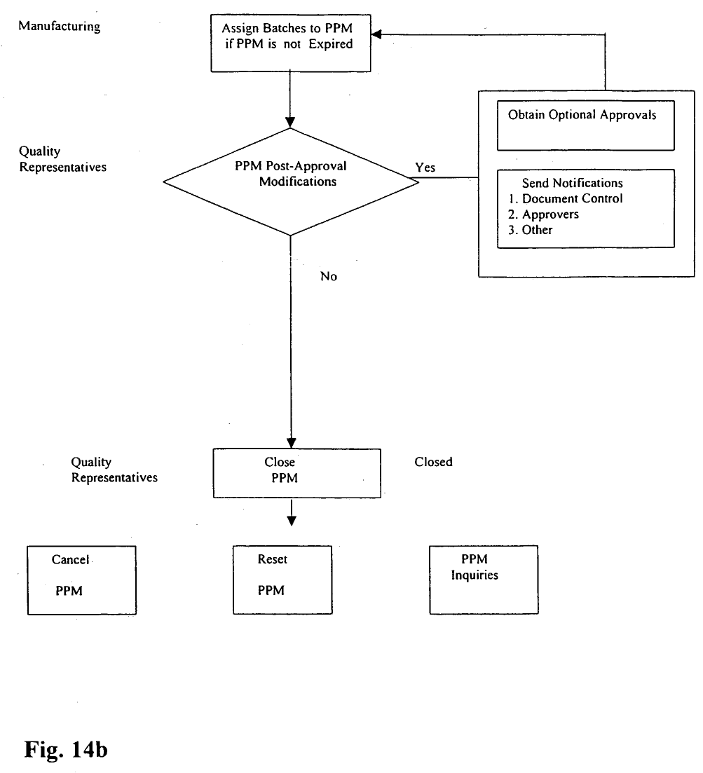

FIGS. 14a and 14b illustrates the high-level process flow of PPM.

A.3. 7 Supplements

Supplements provide the mechanism to add additional information to further support or clarify a Deviation/EMCAR/Comment/PPM and Excursion Notice. The Supplement contains information on the Deviation/EMCAR/Comment/PPM/Excursion Notice number, Supplement description, reason for creating the Supplement, Supplement issued date and the person who initiates the Supplement. The completed Supplement is then reviewed, approved and signed by the responsible department management and quality representatives. If additional Supplements are needed, the DIU/Microbiology/Preclinical R&D personnel are to initiate additional Supplements and obtain required approval and signatures.

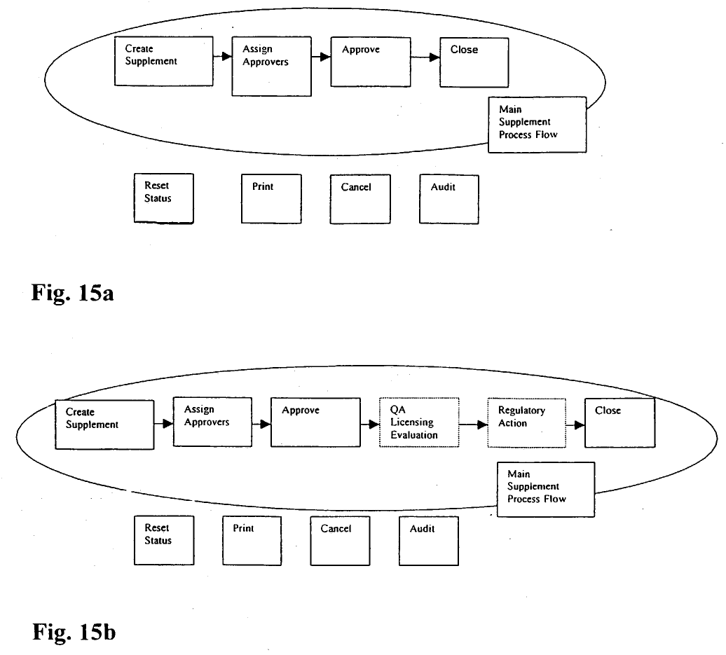

A process flow in case of Type A Supplement (used for clarifications) is shown in FIG. 15a.

A process flow in case of Type B supplement (used for disposition of products of an open deviation) is shown in FIG. 15b.

A. 3.8 Product Disposition

The product disposition module deals with the various process steps in the life cycle of a batch record. The module tracks a batch record starting from its creation to closure. It also helps to track the different issues that might impact product release (such as deviations, EMCARS, PPMs, etc) and aids in the disposition of the products.

A batch record goes through the processes of creation, completion, review and closure. If the record represents a product, it also undergoes a disposition process. In addition to these process steps, a batch record could be impacted by events in the Athena II system, such as deviations, EMCARS, PPMs, VSRs and CCRs. These events trigger holds on the product, which are addressed by the hold process. These holds are automatically resolved by the system when it is determined that the triggering events do not have an impact on release. The automatic holds resolution process addresses the resolution mechanism. The module also has the functionality to place or resolve holds manually.

The Product Disposition module also has the functionality to track issues impacting product release, arising due to change control requests and validation studies. The module incorporates disposition checklists that must be completed prior to product release. Other areas that are within the scope of Product Disposition module are stability sampling, WIP component associations, maintenance of checklists and other checks that must be done before product is released.

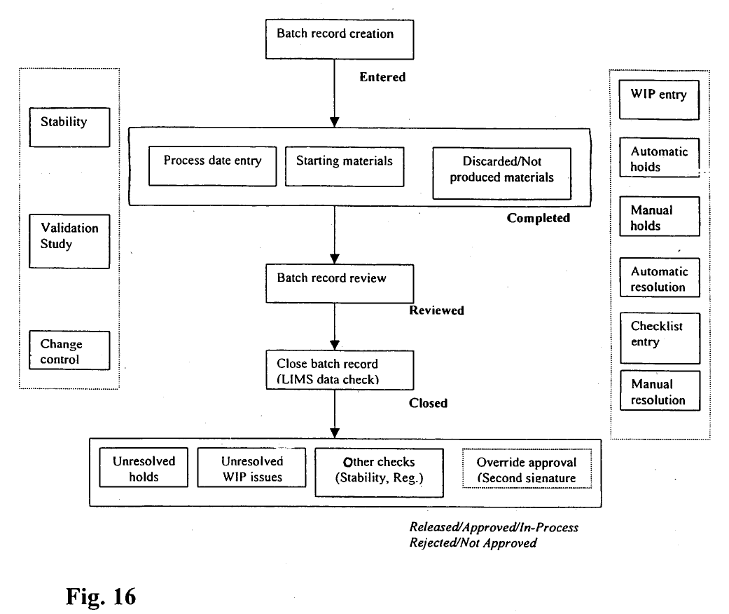

FIG. 16 illustrates the high-level process flow of a batch record.

The product disposition module also supports information links to VSRs and CCRs. The module has a provision for users to enter VSR and CCR data such as VSR/CCR number, start and end date of VSR/CCR and approval date for the VSR/CCR. They also have a list of impacted materials. Any product, whose material number figures in the list of impacted materials of any VSR/CCR, and whose process start and end dates overlap with the start and end dates of the VSR/CCR, have an automatic hold placed on it. The system also has a provision for a user to enter regulatory information for the impacted products. Any product with a regulatory filing of type ‘CBE30’ or ‘Prior Approval’ has an additional regulatory hold placed on it. The system automatically resolves all open holds when the VSR/CCR is closed.

A.4 Information Technology Commissioning Plan

The validation of the Athena II system will address cGMP compliance for computerized systems. All documentation generated in the validation effort of this project will meet SOP IS-26 for Computer Validation. The computer validation effort for Athena II system will be comprised of (but not limited to) the following main documents:

System Definition Document (SDD)

User Requirements

Functional Specifications

Prototype Modules

Detail Design Document

Source Code Inspection (SCI)

Unit Test Protocol (UTP)

Hardware IQ/OQ

Functional Test Protocol (FTP)

Functional Test Results (FTR)

Integration Test Protocol (ITP)

Integration Test Results (ITR)

Performance Qualification Protocol (PQ)

Performance Qualification Summary Report (PQSR)

Data migration test results

Software Qualification Summary Report (SQSR)

The validation will use the software life-cycle approach as the primary approach to qualifying and ensuring that the system functions properly. The Software Life Cycle is the period of time that begins when a software product is conceived and ends when the software is no longer available for use. Documentation is based on “building blocks” of test scripts executed to show specifications have been met. This means that in a phased project such as this, the core/nucleus system was qualified, then all the supporting subsystems were addressed. As subsystems of Athena II were implemented, the validation built upon functional testing already completed.

In this phased approach, it was acceptable that each subsystem requirements and specifications be signed off separately in order for the project to progress. The Validation documents will also be prepared and signed off separately for each subsystem.

A System Definition Document (SDD) was written and approved for each subsystem. The SDD defines all operational and functional requirements of the system/subsystem. Any changes required to the SDD after approval will require an SDD Addendum to be drafted and approved by the same signatories or designees as the original SDD document.

All of the modules of the Athena II system were prototyped and approved not only by the IT project team, but also by the users of the Athena II system. This helped to ensure that the development team and the user groups interpreted the requirements in the same way. It also ensured that any changes to the requirements were caught early on in the process, thereby keeping costs under control.

Hardware Installation Qualification (IQ) and Operational Qualification (OQ) protocols will be written and approved by IT to provide challenges that ensure that specific component of the system are installed and operating correctly. A list of the hardware and software components can be found in the section “Hardware and Software Requirements” of this example. Results of all challenges documented in each of the approved IQ protocols will be compiled for review and approval by IT management.

During the software qualification, IT was responsible for generating detail design documentation. Users reviewed and approved design documents for the appearance and organization as a result of development based on SDD specifications.

After the approval of the SDD, Functional Test Protocols (FTP) were written and approved by IT that defines all the functional test scripts and acceptance criteria required to meet the specifications approved in the SDD. The preparation and approval of functional test protocol was in accordance to the phased approach. Scripts written to test the specifications were based on detail design documents generated.

Upon FTP approval, all tests were executed by skilled person(s) other than those who created the FTP document. Results were then compiled for review and approval. Once the FTP is completed, IT will draft a plan to perform system integration testing, and execute the test scripts. The integration test protocol preparation and approval will be in accordance to the phased approach explained earlier in this example. The integration testing will ensure that the system as a whole is operating correctly after all functions have been tested. During integration testing, the production environment needs to be simulated.

A Software Qualification Summary Report (SQSR) will be drafted by IT and then approved by QC, QA, IT and Computer Validation. This will serve as the formal document to commission the system for use by system users. The SQSR will allow the implementation of Athena II in phases, thereby providing one summary report for each phase of the project.

The Performance Qualification (PQ) protocol will be written by the Computer Validation department to address testing of the complete Athena II system. Once approved, the PQ will be administered by Computer Validation, with the technical consultation of IT. Results will be compiled for review and approval by Computer Validation, IT, QA and QC.

In summary, the objective of the validation is to ensure that the Athena II system performs to the specifications outlined in the System Definition Documents and to document those results.

B Exemplary System Requirements

B.1 Exemplary Hardware Requirements

The Athena II components described on the following pages have been identified to require Installation Qualification (IQ)/Operational Qualification (OQ) Protocols and challenges to show that all the components of the system have been installed properly and operate according to manufacturer's specifications. The IQ results will be incorporated as Information Systems validation documentation, in addition to the functional test protocol that addresses the software qualification. All installation of components is assumed to be onto the Production server unless otherwise noted. A development server is to be used to stage all product functionality prior to the IQ of the hardware and software in to a production server.

| | | | Responsibility |
|---|---|---|---|
| IQ Protocol | Type | IQ Objective | of execution |
| HP/9000 | Hardware | Install Athena | Vendor, IT |
| Development | | II development | |
| Enterprise | | database | |
| server | | | |
| NT | Hardware | Install Athena | Vendor, IT |
| Development | | II application | |
| Application | | development source | |
| Server | | | |
| HP/9000 | Hardware | Install Athena | Vendor, IT |
| Production | | II production | |
| Enterprise | | database | |
| server | | System requirements | |
| | | for 100-150 concurrent | |
| | | users are: | |
| | | K-class or | |
| | | N-class computer | |
| | | Approximately 1024 MB | |
| | | memory | |
| | | Minimum 25 GB disk | |
| | | space using RAID | |
| | | controllers | |
| NT | Hardware | Install Athena II | Vendor, IT |
| Production | | application | |
| Application | | production source | |
| Server | | System requirements | |
| | | for 100-150 concurrent | |
| | | users are: | |
| | | Approximately | |
| | | 128 MB memory | |
| | | Minimum 10 GB | |
| | | disk space | |
| Windows | Hardware | Install client | Vendor, IT |
| 2000 | | operating system | |
| clients | | Install Athena II | |
| | | application | |
| | | registry | |
| Printers | Hardware | Install/qualify | Vendor, IT |
| | | printers directly | |
| | | used for system. | |
| Oracle8 | Software | Install/qualify | IT |
| Server | | database platform | |
| | | on HP/9000 production | |
| | | enterprise server | |
| Oracle | Software | Install/qualify | IT |
| Developer | | application | |
| 6i | | execution platform on | |
| (Runtime) | | production NT | |
| | | application | |
| | | server. | |
| Oracle8 | Software | Install/qualify client software | IT |
| Client | | on Windows 2000 clients for | |
| | | establishing server | |
| | | connectivity on | |
| | | production system. | |
| TCP/IP | Network | Install/qualify | IT |
| | protocol | communications | |
| | | protocol to communicate | |
| | | with local area network | |
| | | devices such as | |
| | | servers, windows 2000 | |
| | | clients. | |

C. Definitions & Abbreviations

The following are non-limiting definitions for various terms and abbreviations used in this example.

| Term | Definition |
|---|---|
| Audit | The process of inspection performed in a firm. |
| Audit | The process of recording and maintaining history |
| Trail | information in an electronic form |
| Authorized | The person who has been granted privileges to |
| User | gain access to the system. |
| cGMP | Current Good Manufacturing Practices |
| Comment | Unusual event which does not impact Product |
| | Safety, Quality, Identity, Potency or Purity |
| | (SQuIPP) or affect a critical point in |
| | product processing |
| Core | The Core subsystem is the nucleus of the system. |
| | It will be used to administer workflow for the |
| | system. |
| Corrective | The implementation of approved action plan to |
| Action | rectify the inspection comments of an audit. |
| CCR | Change Control |
| Development | Stage of project whereby the Athena II system |
| | is installed, programmed, tested, and reviewed |
| | before going to a production environment or |
| | production computer platform. |
| Deviation | Unusual event which may impact SQuIPP or may |
| | affect a critical point. |
| DIU | Deviation Investigation Unit. Personnel |
| | responsible for investigating deviations. |
| EMCAR | Environmental Monitoring and Corrective Action |
| | Report. This documents an investigation performed |
| | in response to an Action condition in the |
| | manufacturing area. |
| Environment | Defined procedures that describes the routine |
| Control | particulate and microbiological monitoring of |
| Excursions | processing and manufacturing areas |
| Program | |
| Excursion | A report issued by Microbiology department to |
| Notice | the appropriate Manufacturing department to |
| | notify them of an alert condition within their |
| | area |
| IPPQC | In-Process Product Quality Control designee |
| | responsible for quality in the manufacturing |
| | areas. |
| IT | Information Technology |
| Manufacturing | The record containing the documentation to |
| Procedure | support the manufacturing/inspection/packaging |
| | of a lot. |
| Notification | The mechanism used to create and route memos |
| | to appropriate personnel |
| PPM | Planned Process Modification is a planned |
| | temporary modification to controlled documents. |
| Privilege | The access level granted to users of the system. |
| | Access levels can be Add, Update, Delete, |
| | Inquire etc. |
| QA | Quality Assurance department |
| QC | Quality Control department |
| QO | Quality Operations |
| R&D | Research and Development |
| SDD | System Definition Document |
| SQuIPP | Safety, Quality, Identity, Purity and Potency. |
| Unusual | A suspected or confirmed undesirable occurrence |
| Event | in the manufacture, processing, testing, storage, |
| | or handling of products, or in existing production |
| | and control records, which is not consistent with |
| | or covered by existing procedures or regulation. |
| Validate | The definition used to indicate the check |
| | performed by the application software for |
| | enforcing business rules, conditions etc. For |
| | e.g. Validate department signifies the check |
| | performed by the system to ensure that the |
| | department number entered by the user exists. |
| VSR | Validation Summary Report |

D. References

D.1 System Definition Documents

Athena II System Definition Document—Core Requirements & Specifications

Athena II System Definition Document—Excursions Requirements & Specifications

Athena II System Definition Document—EMCAR Requirements & Specifications

Athena II System Definition Document—Comments Requirements & Specifications

Athena II System Definition Document—Deviations Requirements & Specifications

Athena II System Definition Document—PPM Requirements & Specifications

Athena II System Definition Document—Supplements Requirements & Specifications

Athena II System Definition Document—Product Disposition Requirements & Specifications

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention. For instance, certain disclosed steps, actions, and/or the like might not be performed in various embodiments.

What is claimed is:

1. A method for pharmaceutical batch record handling, comprising:
creating a batch record corresponding to a pharmaceutical batch product, said record containing initial information corresponding to said batch;
adding to said batch record one or more event data structures, each said data structure corresponding to an event associated with the production of said batch;
adding to said batch record production information relating to said batch;
notifying one or more individuals of a need to perform an approval of said batch record; and
adding to said batch record electronic signatures received from said one or more entities, said electronic signatures corresponding to said approval.

2. The method of claim 1, further compromising:
addressing a hold on said pharmaceutical batch; and
identifying a disposition for said pharmaceutical batch product.

3. The method of claim 2, wherein said hold relates to stability sampling.

4. The method of claim 2, wherein said hold relates to a regulatory check.

5. The method of claim 2, wherein said hold relates to manufacturing procedure work-in-progress component association issues.

6. The method of claim 2, wherein said hold relates to a disposition checklist.

7. The method of claim 2, wherein said hold relates to a validation study.

8. The method of claim 2, wherein said hold relates to a change control request.

9. The method of claim 2, wherein an override is executed to address said hold.

10. The method of claim 1, wherein said initial information comprises manufacturing procedures.

11. The method of claim 1, wherein said initial information comprises standard operating procedures.

12. The method of claim 1, wherein said initial information comprises specifications.

13. The method of claim 1, wherein said initial information comprises equipment information.

14. The method of claim 10, wherein there is work-in-progress information associated with said manufacturing procedures.

15. The method of claim 1, wherein said one or more event data structures include an excursion.

16. The method of claim 1, wherein said one or more event data structures include an environmental monitoring and correction action report.

17. The method of claim 1, wherein said one or more event data structures include a deviation.

18. The method of claim 1, wherein said one or more event data structures include a planned process modification.

19. The method of claim 1, wherein said one or more event data structures include a supplement.

20. The method of claim 1, wherein said production information comprises starting materials information.

21. The method of claim 1, wherein said production information comprises discarded materials information.

22. The method of claim 1, wherein said production information comprises process date entry information.

23. The method of claim 1, wherein said electronic signatures are in compliance with 21 CFR part 11.

24. The method of claim 1, further comprising:
maintaining an audit trail relating to actions performed by the individuals.

25. The method of claim 24, wherein said audit trail associates the individuals with actions.

26. The method of claim 24, wherein said audit trail associates dates and times with actions.

27. The method of claim 1, wherein each of said event data structures contains data submitted by one or more individuals.

28. The method of claim 1, wherein each of said event data structures is electronically signed by one or more individuals.

29. A method for handling an event in pharmaceutical manufacture, comprising:
creating an event data structure corresponding to said event;
dispatching a first notification, said first notification indicating a need to perform a first action regarding said event;
adding to said event data structure information concerning said first action;
adding to said event data structure one or more electronic signatures received in response to said first notification, the one or more electronic signatures received in response to said first notification corresponding to said first action;
dispatching a second notification, said second notification indicating a need to perform a second action regarding said event;
adding to said event data structure information concerning said second action;
adding to said event data structure one or more electronic signatures received in response to said second notification, the one or more electronic signatures received in response to said second notification corresponding to said second action; and
maintaining an audit trail relating to actions performed in response to one or more of the notifications.

30. The method of claim 29, wherein at least one of said first action and said second action concerns regulatory compliance.

31. The method of claim 29, wherein at least one of said first action and said second action concerns investigation.

32. The method of claim 29, wherein at least one of said first action and said second action concerns approval.

33. The method of claim 29, wherein at least one of said first action and said second action concerns selection of personnel.

34. The method of claim 29, wherein said event is an excursion event.

35. The method of claim 29, wherein said event is an environmental monitoring and correction action report event.

36. The method of claim 29, wherein said event is a deviation event.

37. The method of claim 29, wherein said event is a planned process modification event.

38. The method of claim 29, wherein said event is a supplement event.

39. A method for handling a deviation in pharmaceutical manufacture, comprising:
creating a deviation event data structure corresponding to said deviation;
dispatching a first notification, said first notification indicating a need to perform an accuracy check of said deviation event data structure;
adding to said deviation event data structure one or more electronic signatures received in response to said first notification, the one or more electronic signatures received in response to said first notification corresponding to said accuracy check;
dispatching a second notification, said second notification indicating a need to perform an investigation corresponding to said deviation event data structure;
adding to said deviation event data structure one or more electronic signatures received in response to said second notification, the one or more electronic signatures received in response to said second notification corresponding to said investigation;
dispatching a third notification, said third notification indicating a need to perform an approval of said deviation event data structure;
adding to said deviation event data structure one or more electronic signatures received in response to said third notification, the one or more electronic signatures received in response to said third notification corresponding to said approval;
dispatching a fourth notification, said fourth notification indicating a need to determine necessity of regulatory action corresponding to said deviation event data structure; and
adding to said deviation event data structure one or more electronic signatures received in response to said fourth notification, the one or more electronic signatures received in response to said first notification corresponding to the need determination.

40. A system for pharmaceutical batch record handling, comprising:
a memory having program code stored therein; and
a processor operatively connected to said memory for carrying out instructions in accordance with said stored program code;
wherein said program code, when executed by said processor, causes said processor to perform the steps of:
creating a batch record corresponding to a pharmaceutical batch product, said record containing initial information corresponding to said batch;
adding to said batch record one or more event data structures, each said data structure corresponding to an event associated with the production of said batch;
adding to said batch record production information relating to said batch;
notifying one or more individuals of a need to perform an approval of said batch record; and
adding to said batch record electronic signatures received from said one or more entities, said electronic signatures corresponding to said approval.

41. The system of claim 40, wherein said processor further performs the steps of:
addressing a hold on said pharmaceutical batch; and
identifying a disposition for said pharmaceutical batch product.

42. The system of claim 41, wherein said hold relates to stability sampling.

43. The system of claim 41, wherein said hold relates to a regulatory check.

44. The system of claim 41, wherein said hold relates to manufacturing procedure work-in-progress component association issues.

45. The system of claim 41, wherein said hold relates to a disposition checklist.

46. The system of claim 41, wherein said hold relates to a validation study.

47. The system of claim 41, wherein said hold relates to a change control request.

48. The system of claim 41, wherein an override is executed to address said hold.

49. The system of claim 40, wherein said initial information comprises manufacturing procedures.

50. The system of claim 40, wherein said initial information comprises standard operating procedures.

51. The system of claim 40, wherein said initial information comprises specifications.

52. The system of claim 40, wherein said initial information comprises equipment information.

53. The system of claim 49, wherein there is work-in-progress information associated with said manufacturing procedures.

54. The system of claim 40, wherein said one or more event data structures include an excursion.

55. The system of claim 40, wherein said one or more event data structures include an environmental monitoring and correction action report.

56. The system of claim 40, wherein said one or more event data structures include a deviation.

57. The system of claim 40, wherein said one or more event data structures include a planned process modification.

58. The system of claim 40, wherein said one or more event data structures include a supplement.

59. The system of claim 40, wherein said production information comprises starting materials information.

60. The system of claim 40, wherein said production information comprises discarded materials information.

61. The system of claim 40, wherein said production information comprises process date entry information.

62. The system of claim 40, wherein said electronic signatures are in compliance with 21 CFR part 11.

63. The system of claim 40, wherein said processor further performs the steps of:
maintaining an audit trail relating to actions performed by the individuals.

64. The system of claim 63, wherein said audit trail associates the individuals with actions.

65. The system of claim 63, wherein said audit trail associates dates and times with actions.

66. The system of claim 40, wherein each of said event data structures contains data submitted by one or more individuals.

67. The system of claim 40, wherein each of said event data structures is electronically signed by one or more individuals.

68. A system for handling an event in pharmaceutical manufacture, comprising:
a memory having program code stored therein; and
a processor operatively connected to said memory for carrying out instructions in accordance with said stored program code;
wherein said program code, when executed by said processor, causes said processor to perform the steps of:
creating an event data structure corresponding to said event;
dispatching a first notification, said first notification indicating a need to perform a first action regarding said event;
adding to said event data structure information concerning said first action;
adding to said event data structure one or more electronic signatures received in response to said first notification, the one or more electronic signatures received in response to said first notification corresponding to said first action;
dispatching a second notification, said second notification indicating a need to perform a second action regarding said event;
adding to said event data structure information concerning said second action;
adding to said event data structure one or more electronic signatures received in response to said second notification, the one or more electronic signatures received in response to said second notification corresponding to said second action; and
maintaining an audit trail relating to actions performed in response to one or more of the notifications.

69. The system of claim 68, wherein at least one of said first action and said second action concerns regulatory compliance.

70. The system of claim 68, wherein at least one of said first action and said second action concerns investigation.

71. The system of claim 68, wherein at least one of said first action and said second action concerns approval.

72. The system of claim 68, wherein at least one of said first action and said second action concerns selection of personnel.

73. The system of claim 68, wherein said event is an excursion event.

74. The system of claim 68, wherein said event is an environmental monitoring and correction action report event.

75. The system of claim 68, wherein said event is a deviation event.

76. The system of claim 68, wherein said event is a planned process modification event.

77. The system of claim 68, wherein said event is a supplement event.

78. A system for handling a deviation in pharmaceutical manufacture, comprising:
a memory having program code stored therein; and
a processor operatively connected to said memory for carrying out instructions in accordance with said stored program code;
wherein said program code, when executed by said processor, causes said processor to perform the steps of:
creating a deviation event data structure corresponding to said deviation;
dispatching a first notification, said first notification indicating a need to perform an accuracy check of said deviation event data structure;
adding to said deviation event data structure one or more electronic signatures received in response to said first notification, the one or more electronic signatures received in response to said first notification corresponding to said accuracy check;
dispatching a second notification, said second notification indicating a need to perform an investigation corresponding to said deviation event data structure;
adding to said deviation event data structure one or more electronic signatures received in response to said second notification, the one or more electronic signatures received in response to said second notification corresponding to said investigation;
dispatching a third notification, said third notification indicating a need to perform an approval of said deviation event data structure;
adding to said deviation event data structure one or more electronic signatures received in response to said third notification, the one or more electronic signatures received in response to said third notification corresponding to said approval;
dispatching a fourth notification, said fourth notification indicating a need to determine necessity of regulatory action corresponding to said deviation event data structure; and
adding to said deviation event data structure one or more electronic signatures received in response to said fourth notification, the one or more electronic signatures received in response to said first notification corresponding to the need determination.
